(19) United States
(12) Patent Application Publication
(10) Pub. No.: US 2026/0222487 A1
(43) Pub. Date: Jul. 30, 2026

(54) LARGE LANGUAGE MODEL-ASSISTED FRAUDULENT CALL DETECTION

(71) Applicant: McAfee, LLC, San Jose, CA (US)

(72) Inventors: Ayush Agarwal, Purnia (IN); Himanshu Srivastava, Bangalore (IN); Srikanth Nalluri, Bangalore (IN); Dattatraya Kulkarni, Bangalore (IN); Shashank Jain, Bangalore (IN); Sai Dattathrani, Bangalore (IN); Neha Sahoo, Kolkata (IN); Purushothaman Balamurugan, Salem (IN)

(21) Appl. No.: 19/574,154

(22) Filed: Mar. 20, 2026

Related U.S. Application Data
(63) Continuation-in-part of application No. 19/542,475, filed on Feb. 17, 2026.
Application No. 19/542,475 is a continuation-in-part of application No. 19/261,905, filed on Jul. 7, 2025.

(30) Foreign Application Priority Data
Jul. 9, 2024 (IN) 202441052535

(51) Int. Cl. H04M 3/22; G06F 40/284; G06F 40/30; G06F 40/40; G10L 15/26

(52) U.S. Cl. CPC H04M 3/2281; G06F 40/30; G06F 40/40; G06F 40/284; G10L 15/26

(57) ABSTRACT

There is disclosed a system and method for detecting fraudulent intent in a telephonic voice call on a user device. The method includes providing, to a large language model (LLM), a transcript of a portion of an ongoing call between a user and a second party; receiving, from the LLM, respective parameter scores for a plurality of indicia of fraud associated with the transcript of the call; computing a weighted fraud score for the ongoing call via a device-local detector of the user device; and if the weighted fraud score exceeds a threshold, warning the user.

### CROSS REFERENCE TO RELATED APPLICATIONS

This application claims priority to Indian Provisional Application 20/244,1052535 titled “Fraudulent Call Detection,” filed Jul. 9, 2024, which is incorporated herein by reference; and this application claims priority to and is a Continuation-in-Part of U.S. application Ser. No. 19/542,475 filed Feb. 17, 2026, which is a Continuation-in-Part of U.S. application Ser. No. 19/261,905 filed Jul. 7, 2025, all incorporated herein by reference in their entirety.

### FIELD OF THE SPECIFICATION

This application relates in general to computer security, and more particularly though not exclusively to a system and method for large language model-assisted fraudulent call detection.

### BACKGROUND

Telecommunications fraud, commonly known as “vishing” (voice phishing), represents a significant and growing threat to consumers and businesses alike. Fraudulent callers use telephone communications to deceive victims into disclosing sensitive personal information, transferring funds, or taking other actions that result in financial loss or identity theft. These schemes target individuals across all demographics, though elderly and vulnerable populations are often disproportionately affected. The Federal Trade Commission receives millions of fraud reports annually, with telephone fraud consistently ranking among the most common complaint categories.

Traditional approaches to combating telephone fraud rely primarily on caller identification and number-based blocking. These systems maintain databases of known fraudulent numbers, either through crowd-sourced reporting or regulatory agency records, and warn users when incoming calls originate from suspected fraudulent sources. However, such approaches suffer from significant limitations. Fraudsters frequently rotate, lease, or spoof telephone numbers, making number-based identification increasingly unreliable. A number that was legitimate yesterday may be used for fraud today, and conversely, a previously flagged number may have been reassigned to a legitimate user. Furthermore, fraudsters may call from numbers that appear legitimate, including numbers that closely resemble the recipient's own number (neighbor spoofing) or numbers that appear to originate from government agencies or trusted businesses.

More sophisticated fraud detection approaches analyze audio characteristics of the call, such as detecting pre-recorded messages, artificial voices, or voice characteristics associated with known fraudsters. While these approaches can identify certain types of fraud, they may be circumvented by fraudsters using live human operators or advanced voice synthesis technology. Additionally, these approaches typically require analysis of the call audio stream, which may raise privacy concerns or introduce latency that delays warnings until after the fraudulent interaction has progressed significantly. There remains a need for improved systems and methods for detecting fraudulent intent in real-time during ongoing voice calls that can identify fraud based on the semantic content and behavioral patterns of the conversation rather than relying solely on caller identity or audio characteristics.

### BRIEF DESCRIPTION OF THE DRAWINGS

The present disclosure is best understood from the following detailed description when read with the accompanying FIGURES. It is emphasized that, in accordance with standard practice in the industry, various features are not necessarily drawn to scale and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a security ecosystem.

FIG. 2 is a block diagram of selected elements of a fraud call detection system.

FIG. 3 is a block diagram of selected elements of an LLM-based analysis engine.

FIG. 4 is a block diagram of selected elements of a weighted parameter combination system.

FIG. 5 is a block diagram of selected elements of a knowledge distillation system.

FIG. 6 is a flowchart of a method for real-time fraud detection.

FIG. 7 is a flowchart of a feedback and model improvement loop.

FIG. 8 is a flowchart of a method for creating a sparse deep neural network for mobile deployment.

FIG. 9 is a block diagram of selected elements of a hardware platform.

FIG. 10 is a block diagram of selected elements of a network function virtualization (NFV) infrastructure.

FIG. 11 is a block diagram of selected elements of a containerization infrastructure.

FIG. 12 illustrates selected elements of a transformer-based machine learning architecture.

FIG. 13 is a flowchart of a method for transformer-based model inference.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

In an illustrative example of a fraudulent call, the fraudster first tries to establish credibility and trust with the caller, creates a sense of urgency or greed, and then gradually tries to gather sensitive information. The scam may be built around typical events for human users, and can generate a sense of greed and urgency by replicating recent user activities. This manipulative approach lures victims into seemingly genuine scenarios, ultimately leading them to disclose sensitive information.

Some existing solutions help users avoid scam calls by alerting them to incoming calls from known or suspected spam, scam, fraud, or untrustworthy numbers. Data about these numbers may be collected or crowd sourced from publicly available databases. However, fraudsters often rotate, recycle, or lease phone numbers temporarily, making it difficult for existing systems to keep up. This can allow recycled numbers to bypass current safeguards.

This disclosure provides various embodiments for identifying fraudulent calls. These methods involve segmenting calls into short intervals, recognizing recurring patterns in fraudulent calls, detecting artificial voices (e.g., AI or pre-recorded), inferring the fraudster's intent, and offering real-time feedback in the course of a live conversation.

The present specification provides a solution for on-the-fly fraudulent call detection during an ongoing audio call or voice conversation. Upon analyzing an ongoing call and determining that it is likely fraudulent, the system may provide an advisory that enables the user to recognize potentially fraudulent or deceptive conversations. This empowers the user to make informed decisions and be less likely to be a victim of a scam.

Embodiments of the present specification provide progressive analysis of the ongoing conversation, offering feedback as the call progresses. The system may divide the conversation into short segments (e.g., each segment being a few seconds long, such as 10 to 30 seconds). After a few seconds of conversation, the system analyzes the content and assigns a rolling score to indicate the likelihood of fraud for that segment. As the conversation evolves, the system can gain increased confidence either that the call is genuine or that the call is fraudulent.

To improve confidence, the system considers scores from previous segments when evaluating the current one. This allows the system to understand the conversation's overall pattern and how fraud risk evolves.

Furthermore, the system analyzes conversation content and caller behavior. It may detect malicious behavior by comparing the conversation's progression to patterns common in fraudulent calls. For example, typical phases of a fraudulent call might include:
a. A first phase where the caller introduces himself and describes his purpose;
b. A second phase where the caller attempts to establish credibility by building trust and rapport.
c. A third phase where the caller exerts pressure through fabricated problems, false information, or appeals to sympathy, urgency, and greed.
d. A fourth phase involves the caller attempting to collect monetary account information, personally identifying information (PII), or other sensitive information.

Thus, detecting a fraudulent call involves identifying conversations that follow a multiphase pattern. The presence of this pattern itself can indicate fraudulent intent. Furthermore, the system can adapt as fraudsters modify their tactics. For example, they may introduce new phases or alter existing ones. In such cases, a machine learning (ML) system trained on a dataset of fraudulent calls can enhance ongoing detection.

The system disclosed herein may also pay attention to the victim's responses. The system assesses whether the victim seems gullible or easily tricked during conversation. The system may also watch for signs of confusion in the victim's responses, as this may indicate a higher risk of the victim falling for the scam. The system may also have access to a user profile, which can provide contextual information about the targeted caller, such as age, education level, business background, financial context, or other useful information. The user may provide this information voluntarily, or it may be inferred from public or other available records, as appropriate.

In addition to detecting multiphase patterns and analyzing vocal characteristics, embodiments of the present disclosure provide a large language model (LLM)-based analysis engine that evaluates call transcripts in real-time to detect fraudulent intent by assessing key parameters related to the call's context and content. This approach shifts the focus from identifying who is calling to understanding what the caller is saying and how they are saying it.

The LLM-based analysis engine receives a transcript of the ongoing call, which may be generated by a speech-to-text conversion process operating in real-time or near-real-time. The transcript is provided to the LLM along with a carefully engineered prompt that instructs the model to evaluate the conversation according to multiple fraud-indicative parameters. These parameters may include, for example, an absence of acquaintance indicator (whether the caller is known to the user or presents as a stranger), a fake introduction indicator (whether the caller appears to be misrepresenting their identity or affiliation), a suspicious context indicator (whether the conversation content suggests a fabricated or implausible scenario), a privacy breach indicator (whether the caller is inappropriately requesting sensitive information or baiting the user to take an action), and an urgency indicator (whether the caller is creating artificial time pressure or urgency to act quickly).

For each of these parameters, the LLM generates a score indicating the degree to which that parameter suggests fraudulent intent. These individual parameter scores are then combined according to a weighted aggregation scheme to produce a composite fraud likelihood score. The weighting of individual parameters may be based on their relative importance in predicting fraudulent calls, as determined from historical fraud data or machine learning analysis of known fraudulent and legitimate call patterns.

In some embodiments, the weights applied to individual parameter scores may be dynamically adjusted based on the conversation's progression. For example, certain parameters may be given greater weight during early phases of a call, while other parameters may become more heavily weighted as the conversation advances. This dynamic weighting allows the system to account for how fraud indicators manifest differently across the typical progression of a fraudulent call.

The prompt provided to the LLM may be specifically engineered to elicit consistent and reliable fraud assessments. The prompt may include instructions for the LLM to consider contextual factors such as whether the caller's identity is known or unknown, characteristics of the user's profile (such as age or susceptibility indicators), and the current phase of the conversation as inferred from prior analysis. By incorporating this contextual information into the prompt, the LLM can provide more accurate and situationally appropriate fraud assessments.

In some embodiments, the prompts provided to the LLM are dynamically adjusted based on initial segments of the call transcript. As the conversation progresses and additional context becomes available, the prompt may be refined to focus on fraud indicators that are most relevant to the detected conversation type or phase. For example, if initial segments suggest a technical support scam, subsequent prompts may emphasize indicators related to fake introductions and requests for remote access; whereas if initial segments suggest a government impersonation scam, subsequent prompts may emphasize indicators related to urgency and threats of legal action. This dynamic prompt adjustment enables the system to adapt its fraud detection strategy to the specific type of scam that appears to be unfolding.

In some embodiments, the LLM-based analysis engine operates in conjunction with a feedback loop that improves the system's accuracy over time. As calls are processed, anonymized transcripts may be collected (with appropriate user consent) and stored along with their associated fraud scores and outcomes (e.g., whether the call was ultimately determined to be fraudulent or legitimate based on user feedback or subsequent verification). This collected data forms a training dataset that can be used to train more specialized and efficient machine learning models, such as deep neural networks (DNNs), to perform the fraud detection task.

Training specialized DNNs on the collected data offers several advantages. First, a trained DNN may require less computational resources than querying a full LLM for each call segment, enabling more efficient real-time operation on resource-constrained devices such as smartphones. Second, the DNN can be specifically optimized for the fraud detection task, potentially achieving higher accuracy than a general-purpose LLM. Third, the training process can incorporate feedback from real-world use, allowing the system to adapt to evolving fraud tactics and patterns.

In some embodiments, the DNN is specifically architected for processing sequential data such as call transcripts. Suitable architectures include recurrent neural networks (RNNs), long short-term memory (LSTM) networks, gated recurrent units (GRUs), or transformer-based models. These architectures are particularly effective at capturing temporal dependencies and patterns in conversational data, such as the progression from introduction to urgency to information collection that characterizes many fraudulent calls. The sequential nature of call transcripts makes such architectures well-suited for modeling how fraud indicators emerge and evolve over the course of a conversation.

The training data may be used in a transfer learning or knowledge distillation process, where the LLM serves as a “teacher” model that generates labels or guidance for training a smaller “student” DNN model. This approach addresses the challenge of obtaining labeled training data in the fraud detection domain, where examples of fraudulent calls may be relatively rare and where privacy concerns may limit data collection. The LLM, with its broad knowledge of language patterns and fraudulent behaviors, can generate useful training signals even from unlabeled transcripts.

In some embodiments, active learning techniques are employed to prioritize which transcripts are reviewed by human analysts for quality assurance and label verification. The system may identify transcripts where the LLM's fraud assessment has low confidence, where the fraud score is near a decision threshold, or where user feedback contradicts the system's assessment. These edge cases may be prioritized for human review, and the resulting verified labels can be used to further train and refine the DNN model.

The LLM-based analysis may also incorporate confidence scoring alongside the fraud likelihood score. The confidence score indicates the system's certainty in its fraud assessment, which may depend on factors such as the clarity of the transcript, the strength of the fraud indicators, and the consistency of fraud scores across consecutive segments. A call segment with strong fraud indicators across multiple parameters may receive both a high fraud score and a high confidence score, while a call segment with mixed signals may receive a moderate fraud score with a lower confidence score.

In some embodiments, the LLM-based analysis engine is further configured to perform sentiment analysis of the caller's language. Sentiment analysis may identify emotional cues such as aggression, friendliness, nervousness, or confidence that may correlate with deceptive behavior. For example, a caller who sounds overly friendly while making urgent demands may be exhibiting a manipulative pattern, while a caller who sounds nervous when asked for identifying information may be attempting to conceal their true identity. The sentiment analysis results may be incorporated into the fraud assessment as an additional parameter, used to weight other fraud indicators, or provided as contextual information to help the LLM interpret the conversation more accurately.

In some implementations, the LLM-based analysis engine is configured to detect when a caller is using techniques specifically designed to evade keyword-based or pattern-based fraud detection. For example, sophisticated fraudsters may avoid using explicit keywords associated with scams, may vary their language patterns across calls, or may use coded language that appears innocuous to simple analysis. The LLM's ability to understand semantic meaning and context enables it to detect such evasive techniques by recognizing the underlying intent behind seemingly innocent language.

The LLM-based analysis may also be configured to generate explanatory output indicating which specific factors contributed to a given fraud assessment. For example, the LLM may output a natural language explanation such as “The caller claims to represent a government agency but requests payment via gift cards, which is inconsistent with legitimate government practices.” Such explanations can be presented to the user to help them understand why a call is being flagged as potentially fraudulent, increasing user trust in the system and enabling more informed decision-making.

The combination of multiphase pattern detection, vocal characteristic analysis, and LLM-based parameter scoring provides a comprehensive and robust approach to real-time fraud detection. By analyzing multiple aspects of the conversation and combining evidence across multiple segments, the system can achieve high accuracy while providing timely warnings that enable users to protect themselves before disclosing sensitive information.

### Selected Examples

The foregoing can be used to build or embody several example implementations, according to the teachings of the present specification. Some example implementations are included here as non-limiting illustrations of these teachings.

There is disclosed a computer-implemented method of detecting fraudulent intent in a telephonic voice call on a user device. The method includes providing, to a large language model (LLM), a transcript of a portion of an ongoing call between a user and a second party. The method further includes receiving, from the LLM, respective parameter scores for a plurality of indicia of fraud associated with the transcript of the call. The method further includes computing a weighted fraud score for the ongoing call via a device-local detector of the user device. If the weighted fraud score exceeds a threshold, the method includes warning the user.

In some embodiments, the plurality of indicia of fraud comprise at least two of: absence of acquaintance, fake introduction, suspicious context, privacy breach, and urgency.

In another aspect, the method further comprises generating an engineered prompt for the LLM. The engineered prompt instructs the LLM to evaluate the transcript according to the plurality of indicia of fraud. In some embodiments, the engineered prompt incorporates contextual data comprising at least one of: user profile information, call metadata, or conversation phase.

In another aspect, computing the weighted fraud score comprises applying respective weights to the parameter scores and aggregating the weighted parameter scores. In some embodiments, the weights are dynamically adjusted based on a phase of the conversation, the phase comprising at least one of: an introduction phase, a trust-building phase, an urgency phase, or a personal information collection phase. In some embodiments, the weights are adjusted based on a user profile, the user profile indicating at least one of: user age, financial context, or vulnerability factors.

In another aspect, the method further comprises generating a confidence score indicating certainty in the weighted fraud score.

In another aspect, the transcript comprises a segment of the ongoing call, the segment having a duration of 10 to 30 seconds, and the method further comprises analyzing subsequent segments as the call progresses.

In another aspect, the method further comprises converting speech from the ongoing call to text using a speech-to-text engine, wherein the speech-to-text engine is local to the user device or cloud-based.

In another aspect, the method further comprises, after the call ends, receiving user feedback indicating whether the call was fraudulent or legitimate. In some embodiments, the method further comprises anonymizing the transcript by removing or obfuscating personally identifiable information before storing for training purposes.

In some embodiments, the LLM has been trained or fine-tuned on samples of known fraudulent and non-fraudulent calls.

In another aspect, the device-local detector is a deep neural network (DNN) having a plurality of weight values. In some embodiments, the DNN is a sparse DNN. In some embodiments, the method further comprises applying network pruning to the DNN to remove low-magnitude weights, thereby creating a sparse DNN. In some embodiments, the method further comprises applying quantization to the DNN to reduce precision of weight values from 32-bit floating-point to at least one of: 16-bit or 8-bit representations.

In some embodiments, the parameter scores are scalars.

In another aspect, the method further comprises retraining or retuning the LLM with logged calls that have been previously classified by the method. In some embodiments, the retraining is performed via federated learning across multiple user devices without centralizing training data.

In another aspect, the method further comprises training or retraining the LLM with a set of known fraudulent call recordings and known non-fraudulent call recordings. In some embodiments, the method further comprises selecting a proportion of known fraudulent call recordings to known non-fraudulent call recordings to control sensitivity of the LLM. In some embodiments, the proportion is biased towards more fraudulent call recordings to reduce false negatives. In some embodiments, the proportion is biased towards more non-fraudulent call recordings to reduce false positives.

In another aspect, the method further comprises training a smaller neural network via knowledge distillation from the LLM, wherein the LLM serves as a teacher model and the smaller neural network serves as a student model. In some embodiments, the method further comprises deploying the smaller neural network to the user device for local fraud detection.

In another aspect, the method further comprises dynamically adjusting the engineered prompt based on initial segments of the call transcript. As the conversation progresses and additional context becomes available, the prompt is refined to focus on fraud indicators relevant to a detected conversation type.

In another aspect, the method further comprises performing sentiment analysis of the caller's language to identify emotional cues that correlate with deceptive behavior. The sentiment analysis identifies at least one of: aggression, friendliness, nervousness, or confidence.

In another aspect, wherein the DNN is a neural network architecture selected from the group consisting of: a recurrent neural network (RNN), a long short-term memory (LSTM) network, a gated recurrent unit (GRU), and a transformer-based model.

There is disclosed an apparatus comprising means for performing any of the method embodiments described above. In some embodiments, the means for performing the method comprise a processor and a memory. In some embodiments, the memory comprises machine-readable instructions that, when executed, cause the apparatus to perform any of the method embodiments described above. In some embodiments, the apparatus is a computing system.

There is also disclosed at least one computer readable medium comprising instructions that, when executed, implement any of the method embodiments described above or realize an apparatus as described above.

There is disclosed one or more tangible, non-transitory computer-readable storage media having stored thereon executable instructions to detect fraudulent intent in a telephonic voice call on a user device. The instructions instruct a processor to: provide, to a large language model (LLM), a transcript of a portion of an ongoing call between a user and a second party; receive, from the LLM, respective parameter scores for a plurality of indicia of fraud associated with the transcript of the call; compute a weighted fraud score for the ongoing call via a device-local detector of the user device; and if the weighted fraud score exceeds a threshold, warn the user.

In some embodiments, the plurality of indicia of fraud comprise at least two of: absence of acquaintance, fake introduction, suspicious context, privacy breach, and urgency.

In another aspect, the instructions are further to instruct the processor to generate an engineered prompt for the LLM, the engineered prompt instructing the LLM to evaluate the transcript according to the plurality of indicia of fraud. In some embodiments, the engineered prompt incorporates contextual data comprising at least one of: user profile information, call metadata, or conversation phase.

In another aspect, the instructions to compute the weighted fraud score comprise instructions to apply respective weights to the parameter scores and aggregate the weighted parameter scores. In some embodiments, the weights are dynamically adjusted based on a phase of the conversation, the phase comprising at least one of: an introduction phase, a trust-building phase, an urgency phase, or a personal information collection phase. In some embodiments, the weights are adjusted based on a user profile, the user profile indicating at least one of: user age, financial context, or vulnerability factors.

In another aspect, the instructions are further to instruct the processor to generate a confidence score indicating certainty in the weighted fraud score.

In another aspect, the transcript comprises a segment of the ongoing call, the segment having a duration of 10 to 30 seconds, and the instructions are further to instruct the processor to analyze subsequent segments as the call progresses.

In another aspect, the instructions are further to instruct the processor to convert speech from the ongoing call to text using a speech-to-text engine, wherein the speech-to-text engine is local to the user device or cloud-based.

In another aspect, the instructions are further to instruct the processor to, after the call ends, receive user feedback indicating whether the call was fraudulent or legitimate. In some embodiments, the instructions are further to instruct the processor to anonymize the transcript by removing or obfuscating personally identifiable information before storing for training purposes.

In some embodiments, the LLM has been trained or fine-tuned on samples of known fraudulent and non-fraudulent calls.

In another aspect, the device-local detector is a deep neural network (DNN) having a plurality of weight values. In some embodiments, the DNN is a sparse DNN. In some embodiments, the instructions are further to instruct the processor to apply network pruning to the DNN to remove low-magnitude weights, thereby creating a sparse DNN. In some embodiments, the instructions are further to instruct the processor to apply quantization to the DNN to reduce precision of weight values from 32-bit floating-point to at least one of: 16-bit or 8-bit representations.

In some embodiments, the parameter scores are scalars.

In another aspect, the instructions are further to instruct the processor to retrain or retune the LLM with logged calls that have been previously classified. In some embodiments, the retraining is performed via federated learning across multiple user devices without centralizing training data.

In another aspect, the instructions are further to instruct the processor to train or retrain the LLM with a set of known fraudulent call recordings and known non-fraudulent call recordings. In some embodiments, the instructions are further to instruct the processor to select a proportion of known fraudulent call recordings to known non-fraudulent call recordings to control sensitivity of the LLM. In some embodiments, the proportion is biased towards more fraudulent call recordings to reduce false negatives. In some embodiments, the proportion is biased towards more non-fraudulent call recordings to reduce false positives.

In another aspect, the instructions are further to instruct the processor to train a smaller neural network via knowledge distillation from the LLM, wherein the LLM serves as a teacher model and the smaller neural network serves as a student model. In some embodiments, the instructions are further to instruct the processor to deploy the smaller neural network to the user device for local fraud detection.

In another aspect, the instructions are further to instruct the processor to dynamically adjust the engineered prompt based on initial segments of the call transcript, wherein as the conversation progresses and additional context becomes available, the prompt is refined to focus on fraud indicators relevant to a detected conversation type.

In another aspect, the instructions are further to instruct the processor to perform sentiment analysis of the caller's language to identify emotional cues that correlate with deceptive behavior, wherein the sentiment analysis identifies at least one of: aggression, friendliness, nervousness, or confidence.

In another aspect, the DNN is a neural network architecture selected from the group consisting of: a recurrent neural network (RNN), a long short-term memory (LSTM) network, a gated recurrent unit (GRU), and a transformer-based model.

There is disclosed a computing apparatus configured to detect fraudulent intent in a telephonic voice call. The computing apparatus comprises a hardware platform including a processor circuit and a memory. The memory has encoded therein instructions to instruct the processor circuit to: provide, to a large language model (LLM), a transcript of a portion of an ongoing call between a user and a second party; receive, from the LLM, respective parameter scores for a plurality of indicia of fraud associated with the transcript of the call; compute a weighted fraud score for the ongoing call via a device-local detector; and if the weighted fraud score exceeds a threshold, warn the user.

In some embodiments, the plurality of indicia of fraud comprise at least two of: absence of acquaintance, fake introduction, suspicious context, privacy breach, and urgency.

In another aspect, the instructions are further to instruct the processor circuit to generate an engineered prompt for the LLM, the engineered prompt instructing the LLM to evaluate the transcript according to the plurality of indicia of fraud. In some embodiments, the engineered prompt incorporates contextual data comprising at least one of: user profile information, call metadata, or conversation phase.

In another aspect, the instructions to compute the weighted fraud score comprise instructions to apply respective weights to the parameter scores and aggregate the weighted parameter scores. In some embodiments, the weights are dynamically adjusted based on a phase of the conversation, the phase comprising at least one of: an introduction phase, a trust-building phase, an urgency phase, or a personal information collection phase. In some embodiments, the weights are adjusted based on a user profile, the user profile indicating at least one of: user age, financial context, or vulnerability factors.

In another aspect, the instructions are further to instruct the processor circuit to generate a confidence score indicating certainty in the weighted fraud score.

In another aspect, the transcript comprises a segment of the ongoing call, the segment having a duration of 10 to 30 seconds, and the instructions are further to instruct the processor circuit to analyze subsequent segments as the call progresses.

In another aspect, the instructions are further to instruct the processor circuit to convert speech from the ongoing call to text using a speech-to-text engine, wherein the speech-to-text engine is local to the apparatus or cloud-based.

In another aspect, the instructions are further to instruct the processor circuit to, after the call ends, receive user feedback indicating whether the call was fraudulent or legitimate. In some embodiments, the instructions are further to instruct the processor circuit to anonymize the transcript by removing or obfuscating personally identifiable information before storing for training purposes.

In some embodiments, the LLM has been trained or fine-tuned on samples of known fraudulent and non-fraudulent calls.

In another aspect, the device-local detector is a deep neural network (DNN) having a plurality of weight values. In some embodiments, the DNN is a sparse DNN. In some embodiments, the instructions are further to instruct the processor circuit to apply network pruning to the DNN to remove low-magnitude weights, thereby creating a sparse DNN. In some embodiments, the instructions are further to instruct the processor circuit to apply quantization to the DNN to reduce precision of weight values from 32-bit floating-point to at least one of: 16-bit or 8-bit representations.

In some embodiments, the parameter scores are scalars.

In another aspect, the instructions are further to instruct the processor circuit to retrain or retune the LLM with logged calls that have been previously classified. In some embodiments, the retraining is performed via federated learning across multiple user devices without centralizing training data.

In another aspect, the instructions are further to instruct the processor circuit to train or retrain the LLM with a set of known fraudulent call recordings and known non-fraudulent call recordings. In some embodiments, the instructions are further to instruct the processor circuit to select a proportion of known fraudulent call recordings to known non-fraudulent call recordings to control sensitivity of the LLM. In some embodiments, the proportion is biased towards more fraudulent call recordings to reduce false negatives. In some embodiments, the proportion is biased towards more non-fraudulent call recordings to reduce false positives.

In another aspect, the instructions are further to instruct the processor circuit to train a smaller neural network via knowledge distillation from the LLM, wherein the LLM serves as a teacher model and the smaller neural network serves as a student model. In some embodiments, the instructions are further to instruct the processor circuit to deploy the smaller neural network to the user device for local fraud detection.

In another aspect, the instructions are further to instruct the processor circuit to dynamically adjust the engineered prompt based on initial segments of the call transcript, wherein as the conversation progresses and additional context becomes available, the prompt is refined to focus on fraud indicators relevant to a detected conversation type.

In another aspect, the instructions are further to instruct the processor circuit to perform sentiment analysis of the caller's language to identify emotional cues that correlate with deceptive behavior, wherein the sentiment analysis identifies at least one of: aggression, friendliness, nervousness, or confidence.

In another aspect, the DNN is a neural network architecture selected from the group consisting of: a recurrent neural network (RNN), a long short-term memory (LSTM) network, a gated recurrent unit (GRU), and a transformer-based model.

In some embodiments, the computing apparatus is a desktop computer. In some embodiments, the computing apparatus is a laptop computer. In some embodiments, the computing apparatus is a tablet computer. In some embodiments, the computing apparatus is a smart phone. In some embodiments, the computing apparatus is a server. In some embodiments, the computing apparatus further comprises a guest infrastructure to realize server functions. In some embodiments, the guest infrastructure comprises virtualization. In some embodiments, the guest infrastructure comprises containerization.

### DETAILED DESCRIPTION OF THE DRAWINGS

A system and method for detecting fraudulent intent in voice calls will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to imply a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

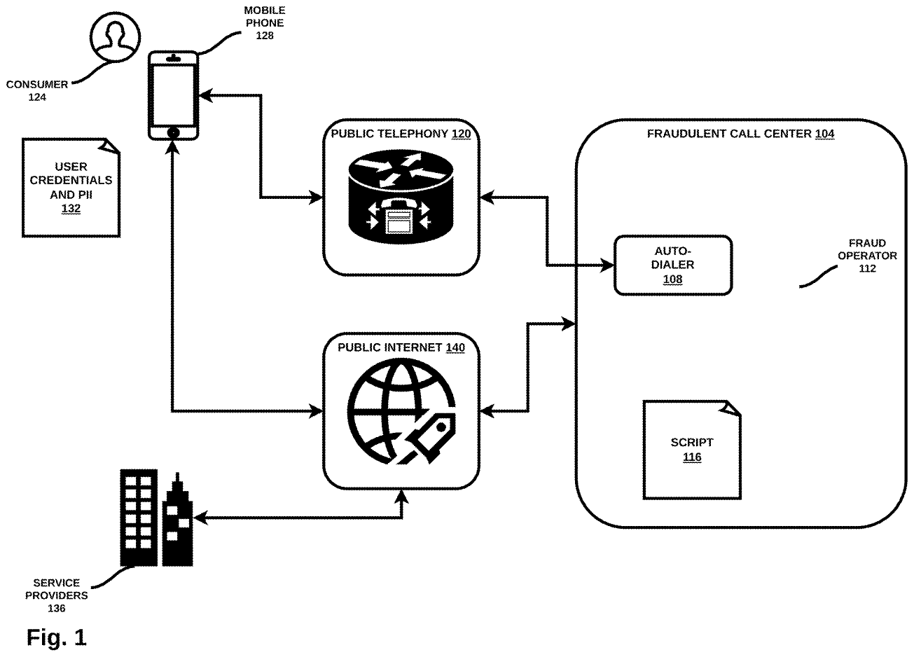

### FIG. 1

FIG. 1 is a block diagram of a computer consumer protection ecosystem 100. The ecosystem includes a consumer 124 operating a mobile device 128. Consumer 124 has access to user credentials and PII 132, which may include, for example, banking information, passwords, social security numbers, and electronic access to money, accounts, and services. These data points are examples of “sensitive user data” encompassed within PII 132.

A fraudulent call center 104 may employ multiple fraud operators 112 who contact users via an autodialer 108. The autodialer operates on the public telephone network 120 to call mobile phones 128, allowing fraud operators 112 to speak with users (e.g., consumers 124). Fraud operators 112 may attempt to gain access to PII 132 by contacting consumers 124 via mobile phone 128. During a call, fraud operators 112 may use a script 116 to guide their interactions with consumers 124 and ultimately obtain PII 132.

Consumer 124 may possess varying levels of wariness or sophistication. A well-trained or highly suspicious consumer 124 might recognize fraudulent call characteristics and avoid PII loss. Conversely, a less sophisticated or more gullible consumer 124 could be susceptible to fraud operator 112 using script 116 to gain access to PII 132.

A consumer 124 subscribes to a protection service provided by service provider 136. The service provider 136 may be a security services provider, such as McAfee or another suitable alternative. A mobile phone 128 accesses service provider 136 via the public internet 140. Service provider 136 may offer a cloud-based service that complements local computing on mobile phone 128.

When autodialer 108 places a call to mobile phone 128 through the public telephone network 120, software on mobile phone 128 may recognize that the call is coming from an unknown or untrusted number. Even if the number does not have a crowd-sourced known fraudulent reputation, the software may recognize that consumer 124 may be in danger of a fraudulent call. In this case, mobile phone 128 may operate its consumer protection engine to analyze the call for indicia of fraud or deceit. In some cases, the protection engine may operate even if the incoming phone number is in the user's contact list or phone book. Some frauds are “long cons,” in which the fraudster tries to gain trust over time, and thus may have previously contacted the user. Furthermore, even supposedly-trusted contacts, such as family members or alleged friends may try to take advantage of vulnerable users, such as elderly or disabled users. In some cases, a sensitivity level can be selected as a user option, to provide a tradeoff between protection and false positives. In other cases, a sensitivity level may be suggested based on the user's inherent risk profile (e.g., age, background, education, or similar).

The call analysis may occur in real-time during the call to identify fraudulent intent and warn the user (consumer 124) before personally identifiable information (PII) 132 is compromised. Mobile phone 128 may access service provider 136 via public Internet 140 to enhance its local analysis, such as by using deep neural networks (DNN), large language models (LLM), or other services not practical to run on mobile phone 128. If mobile phone 128 determines that the call is likely fraudulent, it may provide a warning to consumer 124 (e.g., visible, audible, and/or haptic), autonomously terminate the call under certain configurations, or take other remedial action against fraudulent call center 104.

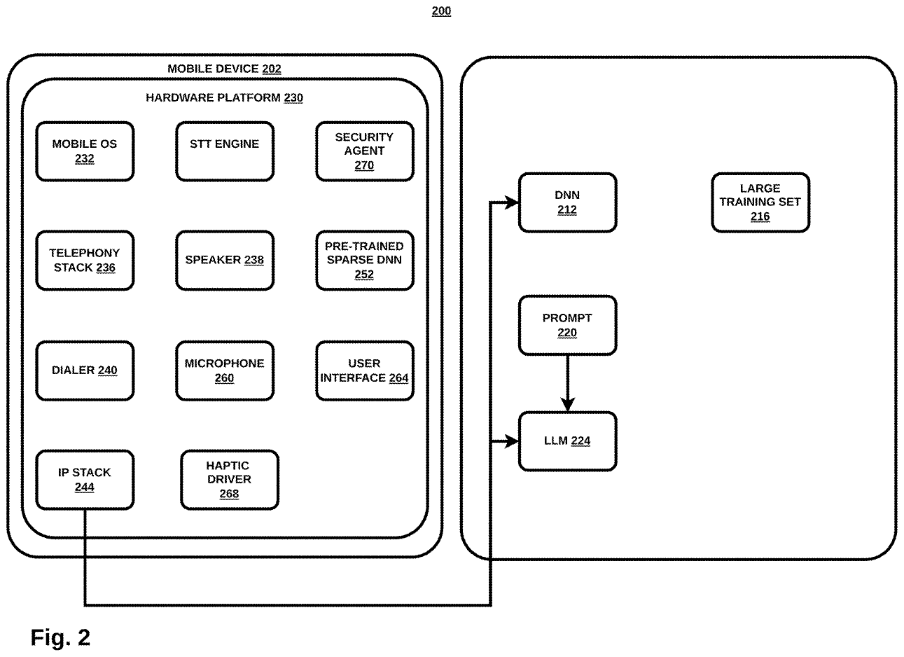

### FIG. 2

FIG. 2 is a block diagram of selected elements of a fraudulent call analysis ecosystem 200. Fraudulent call analysis ecosystem 200 may operate with a mobile device 202, running on a hardware platform 230. Hardware platform 230 provides the necessary hardware, firmware, and software services to interact with a human user.

Hardware platform 230 includes a mobile operating system 232, which may be for example Android, IOS, Windows mobile edition, or any other suitable operating system for mobile device 202.

A telephony stack 236 provides the hardware and software to interact with a public telephone network, such as a cellular or digital communication network. This may include, for example, a mobile telephone transceiver and software to make voice calls. A dialer 240 may include hardware and software to place outgoing calls to the mobile telephone network. Telephony stack 236 also has the capacity to receive incoming calls.

An Internet Protocol (IP) stack 244 may include TCP/IP services to communicate with the Internet and with network-based services. IP stack 244 may provide a connection to cloud-based services, which may provide supplemental fraud detection capabilities.

Mobile device 202 may also include a speech-to-text (STT) engine 248. STT engine 248 may convert ongoing calls to text in real-time or near-real-time, enabling processing by a large language model (LLM).

A speaker 238 provides an interface for the human user to hear calls and can be manipulated by security agent 270 to deliver audible warnings if the call is suspected to be a scam.

Microphone 260 provides user input to the call, and can be used as an interface to provide call data to STT engine 248 for processing by security agent 270.

A haptic driver 268 may provide haptic feedback, such as a buzz or shake, if the security agent 270 suspects a scam call.

Security agent 270 may include a pre-trained sparse DNN 252, which can detect scam calls by recognizing known phases of a scam. Pre-trained sparse DNN 252 can interoperate with cloud-based services, providing access to a larger and more featureful DNN 212. Security agent 270 may also interface with an LLM 224 using a prompt 220 to help detect voice authenticity and scam-like behavior. Both DNN 212 and LLM 224 can be trained on a large training set 216.

A user interface 264 within security agent 270 may provide visual representations of the call status and analyze its legitimacy. Security agent 270 may launch user interface 264 under uncertain conditions, such as calls from unknown or untrusted numbers.

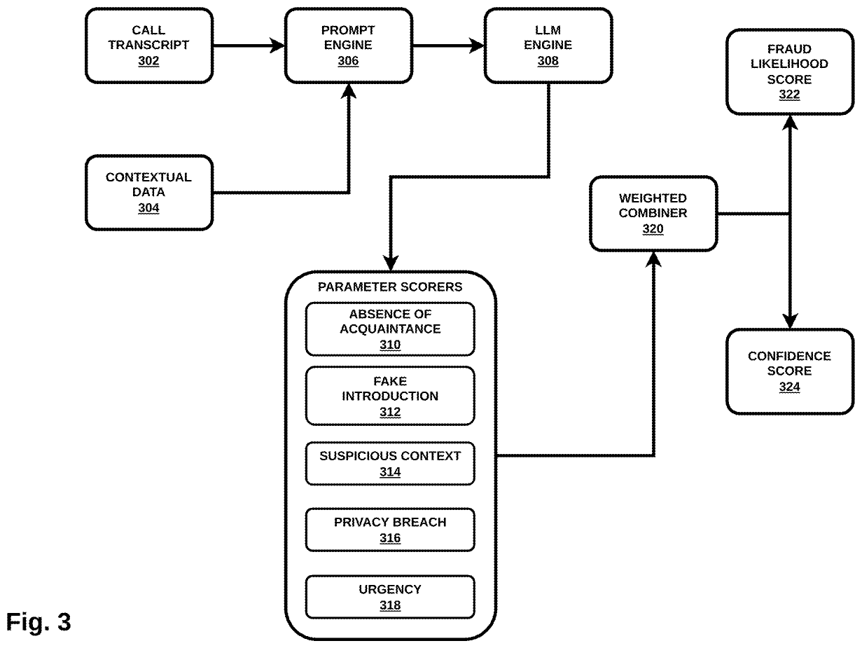

### FIG. 3

FIG. 3 is a block diagram of an LLM-based analysis engine 300 for detecting fraudulent intent in voice calls. The analysis engine 300 receives input data from an ongoing voice call and produces fraud likelihood assessments that may be used to warn users of potentially fraudulent calls in real-time.

The analysis engine 300 receives a call transcript 302, which may be generated by a speech-to-text conversion process operating on the audio stream of an ongoing call. Call transcript 302 may include the textual representation of the conversation between the user and the caller, including both parties' spoken words. In some embodiments, call transcript 302 may be segmented into intervals, such as 10-second, 20-second, or 30-second segments, to enable progressive analysis as the call progresses. Call transcript 302 may be generated by any suitable speech-to-text engine, including cloud-based services (e.g., Google Speech-to-Text, Amazon Transcribe, Microsoft Azure Speech) or local transcription models (e.g., OpenAI Whisper).

Contextual data 304 may also be provided to the analysis engine 300. Contextual data 304 may include information about the user, such as user profile information, age, education level, financial context, or other characteristics that may be relevant to assessing fraud risk. Contextual data 304 may also include information about the call itself, such as the incoming phone number, whether the number is known or unknown to the user, geographic information associated with the number, or crowd-sourced reputation data about the number. In some embodiments, contextual data 304 may include information about the current phase of the conversation as inferred from prior analysis of earlier segments.

Call transcript 302 and contextual data 304 are provided to a prompt engine 306. Prompt engine 306 may be configured to generate an engineered prompt for a large language model (LLM) engine 308. The prompt may be specifically designed to instruct LLM engine 308 to evaluate the call transcript according to multiple fraud-indicative parameters. Prompt engine 306 may incorporate the contextual data 304 into the prompt to provide situationally-relevant instructions to LLM engine 308. For example, if contextual data 304 indicates that the user is elderly, prompt engine 306 may generate a prompt that instructs LLM engine 308 to pay particular attention to fraud patterns commonly targeting elderly individuals. In some embodiments, prompt engine 306 may dynamically adjust the prompt based on the conversation's progression, emphasizing different fraud indicators during different phases of the call.

LLM engine 308 may be any suitable large language model capable of understanding and analyzing conversational text. Examples of suitable LLMs include GPT models (e.g., GPT-3.5, GPT-4), Claude models, LLAMA models, or other transformer-based language models. LLM engine 308 may be hosted on a remote server and accessed via an API, or may be operated locally on the user's device. In some embodiments, LLM engine 308 may be specifically fine-tuned for fraud detection tasks using training data derived from known fraudulent and legitimate call transcripts.

LLM engine 308 outputs parameter scores to a set of parameter scorers. The parameter scorers evaluate the call according to multiple fraud-indicative parameters. In the illustrated embodiment, the parameter scorers include an absence of acquaintance scorer 310, a fake introduction scorer 312, a suspicious context scorer 314, a privacy breach scorer 316, and an urgency scorer 318.

Absence of acquaintance scorer 310 may generate a score indicating whether the caller presents as a stranger unknown to the user. A high score from absence of acquaintance scorer 310 may indicate that the caller is presenting as someone the user does not know or has not previously interacted with, which may be a fraud indicator if combined with other suspicious factors. However, a call from an unknown party is not inherently fraudulent; thus, absence of acquaintance scorer 310 may be combined with other parameter scores to provide a more complete fraud assessment.

Fake introduction scorer 312 may generate a score indicating whether the caller appears to be misrepresenting their identity or affiliation. For example, if the caller claims to represent a government agency, bank, or well-known company, fake introduction scorer 312 may evaluate whether the caller's statements are consistent with legitimate representatives of such organizations. A high score from fake introduction scorer 312 may indicate that the caller's introduction contains inconsistencies, implausible claims, or other indicators of fraudulent impersonation.

Suspicious context scorer 314 may generate a score indicating whether the conversation content suggests a fabricated or implausible scenario. For example, a caller claiming that the user owes unpaid taxes that must be paid immediately via gift cards may receive a high score from suspicious context scorer 314, as this scenario is inconsistent with legitimate government practices. Suspicious context scorer 314 may evaluate the overall narrative presented by the caller and assess whether it follows patterns commonly associated with known fraud schemes.

Privacy breach scorer 316 may generate a score indicating whether the caller is inappropriately requesting sensitive information. A high score from privacy breach scorer 316 may indicate that the caller is requesting information such as social security numbers, bank account details, credit card numbers, passwords, or other personally identifiable information (PII) in a manner that is inconsistent with legitimate business practices. Privacy breach scorer 316 may also score the caller's attempts to “bait” the user into taking actions that may compromise their privacy or security.

Urgency scorer 318 may generate a score indicating whether the caller is creating artificial time pressure or urgency to act quickly. Many fraudulent calls employ urgency as a tactic to pressure victims into making hasty decisions without proper verification. A high score from urgency scorer 318 may indicate that the caller is emphasizing time pressure, such as claiming that the user must act “right now” or face immediate consequences.

The parameter scores from scorers 310, 312, 314, 316, and 318 are provided to a weighted combiner 320. Weighted combiner 320 may combine the individual parameter scores according to a weighted aggregation scheme to produce a composite fraud assessment. The weights applied to each parameter score may be based on the relative importance of each parameter in predicting fraudulent calls, as determined from historical fraud data or machine learning analysis of known fraudulent and legitimate call patterns.

Weighted combiner 320 outputs a fraud likelihood score 322. Fraud likelihood score 322 may be a numerical value indicating the probability or likelihood that the call is fraudulent. In some embodiments, fraud likelihood score 322 may be a value between 0 and 1, between 0 and 100, or any other suitable scale. Fraud likelihood score 322 may be compared against a threshold to determine whether to generate a warning to the user. In some embodiments, fraud likelihood score 322 may be categorized into risk levels, such as “low risk,” “medium risk,” and “high risk.”

Weighted combiner 320 may also output a confidence score 324. Confidence score 324 may indicate the system's certainty in its fraud assessment. A high confidence score 324 may indicate that the fraud assessment is based on strong fraud indicators across multiple parameters and consistent evidence across consecutive segments. A low confidence score 324 may indicate mixed signals or insufficient evidence, which may prompt the system to continue monitoring before making a definitive assessment. Confidence score 324 may be used to determine whether to present a warning to the user immediately or to continue collecting additional evidence before presenting the warning.

In some embodiments, the parameter scorers 310, 312, 314, 316, and 318 may generate intermediate outputs that are also stored for later analysis. These intermediate outputs may include natural language explanations from the LLM describing why particular scores were assigned, which may be useful for user feedback, system debugging, or training data generation.

In alternative embodiments, the analysis engine 300 may include additional or different parameter scorers. For example, the system may include scorers for detecting emotional manipulation, detecting scripted language patterns, detecting voice characteristics associated with deception, or other fraud indicators. The specific set of parameter scorers may be configurable based on the deployment context, user preferences, or evolving fraud patterns.

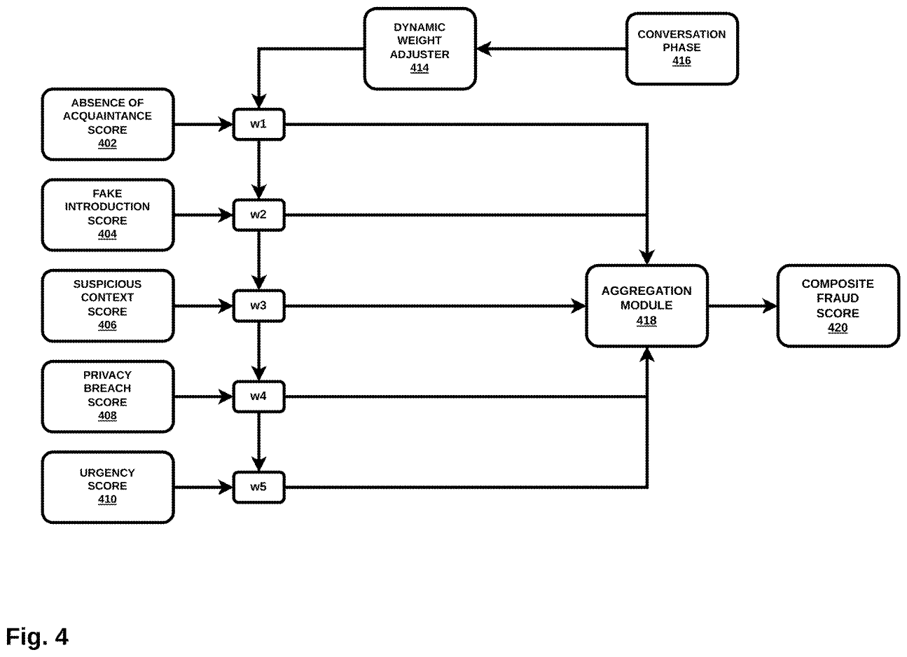

### FIG. 4

FIG. 4 is a block diagram of a weighted parameter combination system 400 for generating a composite fraud score from multiple parameter scores. The weighted parameter combination system 400 receives individual parameter scores and applies dynamic weights to produce a composite fraud score that accurately reflects the likelihood of fraudulent intent.

The weighted parameter combination system 400 receives multiple parameter scores from the LLM-based analysis. These include an absence of acquaintance score 402, a fake introduction score 404, a suspicious context score 406, a privacy breach score 408, and an urgency score 410. Each of these parameter scores may be generated by the LLM engine based on its analysis of the call transcript, as described with respect to FIG. 3.

Each parameter score is associated with a corresponding weight. The absence of acquaintance score 402 is associated with weight w1 412a. The fake introduction score 404 is associated with weight w2 412b. The suspicious context score 406 is associated with weight w3 412c. The privacy breach score 408 is associated with weight w4 412d. The urgency score 410 is associated with weight w5 412e.

The weights w1 through w5 may be determined based on the relative predictive importance of each parameter in identifying fraudulent calls. In some embodiments, the weights may be learned from historical data through machine learning techniques. For example, logistic regression or other classification algorithms may be applied to a labeled dataset of fraudulent and legitimate calls to determine optimal weight values. In other embodiments, the weights may be set based on expert knowledge of fraud patterns. The weights may be normalized such that they sum to 1.0 or to 100%.

A dynamic weight adjuster 414 may dynamically adjust the weights w1 through w5 based on contextual factors. The dynamic weight adjuster 414 may receive input from a conversation phase module 416, which provides information about the current phase of the conversation. Conversation phase module 416 may determine the phase of the call based on analysis of the transcript, such as whether the call is in an introduction phase, a trust-building phase, an urgency/pressure phase, or a personal information collection phase.

Different weights may be appropriate for different phases of the conversation. For example, during the introduction phase of a call, the absence of acquaintance score 402 and fake introduction score 404 may be more heavily weighted, as these parameters are most relevant during the initial establishment of the caller's identity. During later phases of the call, the privacy breach score 408 and urgency score 410 may be more heavily weighted, as these parameters become more indicative of fraudulent intent as the caller attempts to extract sensitive information or create time pressure.

In some embodiments, dynamic weight adjuster 414 may also adjust weights based on the user's profile or risk characteristics. For example, if the user profile indicates that the user is elderly, dynamic weight adjuster 414 may increase the weight for urgency score 410, as elderly individuals may be particularly susceptible to urgency-based fraud tactics. In another example, if the user profile indicates that the user has high financial assets, dynamic weight adjuster 414 may increase the weight for privacy breach score 408, as financial fraud may pose a higher risk to such users.

The weighted parameter scores are provided to an aggregation module 418. Aggregation module 418 combines the weighted parameter scores to produce a composite fraud score 420. In some embodiments, aggregation module 418 may compute a weighted sum or weighted average of the parameter scores. For example, the composite fraud score 420 may be computed as:

$$Composite Score = w 1 \times Score 402 + w 2 \times Score 404 + w 3 \times Score 406 + w 4 \times Score 408 + w 5 \times Score 410$$

In alternative embodiments, aggregation module 418 may use more sophisticated aggregation methods. For example, aggregation module 418 may apply a non-linear transformation to the parameter scores before weighting, may use a machine learning model to combine the scores, or may apply threshold logic that requires certain minimum scores on specific parameters before flagging a call as fraudulent.

The composite fraud score 420 may be compared against a threshold to determine whether the call should be flagged as potentially fraudulent. The threshold may be configurable, and may be set based on the desired balance between detecting true fraud (true positives) and avoiding false alarms (false positives). A lower threshold may result in more warnings but also more false positives, while a higher threshold may result in fewer false positives but potentially missing some fraudulent calls.

In some embodiments, aggregation module 418 may also generate a confidence score that indicates the system's certainty in the composite fraud score 420. The confidence score may be based on factors such as the consistency of the parameter scores, the amount of transcript data analyzed, and the strength of the fraud indicators detected.

In some embodiments, the weighted parameter combination system 400 may be implemented using a neural network that learns the optimal combination of parameter scores from labeled training data. In such embodiments, the weights w1 through w5 may be learned parameters of the neural network, and the aggregation module 418 may be implemented as one or more neural network layers.

In alternative embodiments, the weighted parameter combination system 400 may include additional parameter scores and weights. For example, the system may include scores for emotional manipulation, script detection, voice stress analysis, or other fraud indicators. The system may be extended to accommodate any number of parameter scores and weights.

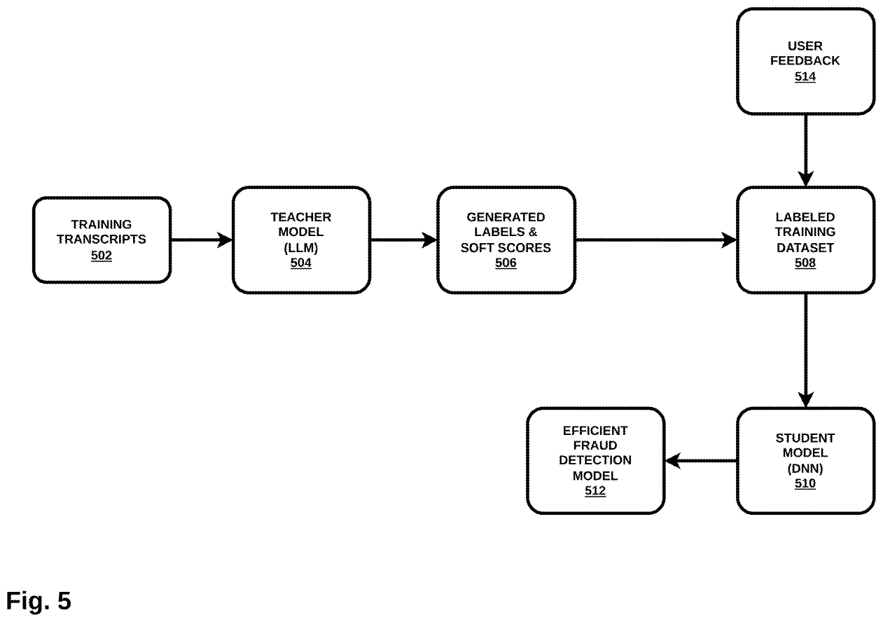

### FIG. 5

FIG. 5 is a block diagram of a knowledge distillation system 500 for training an efficient fraud detection model from a large language model. The knowledge distillation system 500 addresses the computational cost and latency challenges of running a full LLM for real-time fraud detection by training a smaller, more efficient deep neural network (DNN) that can perform fraud detection with reduced computational requirements.

Training transcripts 502 may be collected from analyzed calls. Training transcripts 502 may include transcripts of calls that have been processed by the system, including both calls that were flagged as potentially fraudulent and calls that were determined to be legitimate. In some embodiments, training transcripts 502 may be collected with user consent and may be anonymized to protect user privacy. Training transcripts 502 may include a diverse set of call types, including fraudulent calls of various types (e.g., tax scams, tech support scams, lottery scams, romance scams) and legitimate calls (e.g., business calls, personal calls, customer service calls).

Training transcripts 502 are provided to a teacher model 504. Teacher model 504 may be a large language model (LLM) that has been configured for fraud detection, such as the LLM engine 308 described with respect to FIG. 3. Teacher model 504 may analyze each training transcript and generate fraud assessments, including parameter scores for the various fraud-indicative parameters (e.g., absence of acquaintance, fake introduction, suspicious context, privacy breach, urgency).

Teacher model 504 outputs generated labels and soft scores 506. The generated labels may include a binary classification (fraudulent or legitimate) for each transcript. The soft scores may include probability distributions or continuous scores that indicate the teacher model's assessment of fraud likelihood. Unlike hard labels that simply indicate a class (e.g., “fraudulent” or “legitimate”), soft scores may capture the teacher model's uncertainty and the nuanced relationship between transcript features and fraud likelihood. For example, soft scores may include a fraud probability (e.g., 0.73), parameter scores for each fraud indicator, or logits from the teacher model's output layer.

User feedback 514 may also be collected from users who have experienced calls analyzed by the system. User feedback 514 may include explicit feedback from users indicating whether a call flagged as fraudulent was actually fraudulent or was a false positive, or whether a call not flagged as fraudulent was actually a fraudulent call that was missed. User feedback 514 may provide ground truth labels that can be used to validate or correct the labels generated by teacher model 504.

The generated labels and soft scores 506, along with user feedback 514, are used to create a labeled training dataset 508. Labeled training dataset 508 may include transcripts with associated labels and scores that can be used to train a student model. In some embodiments, labeled training dataset 508 may be curated to ensure quality, such as by verifying labels through human review or by filtering out low-confidence assessments.

Labeled training dataset 508 is used to train a student model 510. Student model 510 may be a deep neural network (DNN) that is smaller and more computationally efficient than teacher model 504. For example, student model 510 may have fewer parameters, fewer layers, or a simpler architecture than teacher model 504. In some embodiments, student model 510 may be specifically designed for efficient execution on mobile devices or embedded systems. Student model 510 may be trained using supervised learning techniques, where the labels and soft scores from labeled training dataset 508 serve as training targets.

In some embodiments, student model 510 may be trained using knowledge distillation techniques. Knowledge distillation is a machine learning technique where a smaller model (the student) is trained to mimic the behavior of a larger model (the teacher). The student model may be trained to match the soft outputs of the teacher model, not just the hard labels. This may allow the student model to capture nuanced patterns that the teacher model has learned, even though the student model has limited capacity. In some embodiments, the training loss may be a combination of hard label loss (measuring how well the student matches the true labels) and distillation loss (measuring how well the student matches the teacher's soft outputs).

After training, student model 510 becomes an efficient fraud detection model 512. Efficient fraud detection model 512 may be deployed to end-user devices, such as smartphones or tablets, for real-time fraud detection. Because efficient fraud detection model 512 is smaller and more efficient than teacher model 504, it may be able to process transcripts with lower latency and reduced computational cost, enabling real-time analysis on resource-constrained devices.

In some embodiments, efficient fraud detection model 512 may be periodically updated by collecting additional training data and repeating the knowledge distillation process. This may allow the model to adapt to evolving fraud tactics and improve its accuracy over time. Updates may be delivered to user devices via software updates or model updates pushed from a central server.

In alternative embodiments, student model 510 may be trained using additional techniques such as quantization-aware training, pruning, or architecture optimization. These techniques may further reduce the computational requirements of the model, enabling deployment on a wider range of devices.

In some embodiments, active learning techniques may be used to prioritize which transcripts are reviewed by human analysts. For example, transcripts where the teacher model has low confidence, where the fraud score is near a decision threshold, or where user feedback contradicts the model's assessment may be flagged for human review. The verified labels from human review may be used to further improve the quality of labeled training dataset 508.

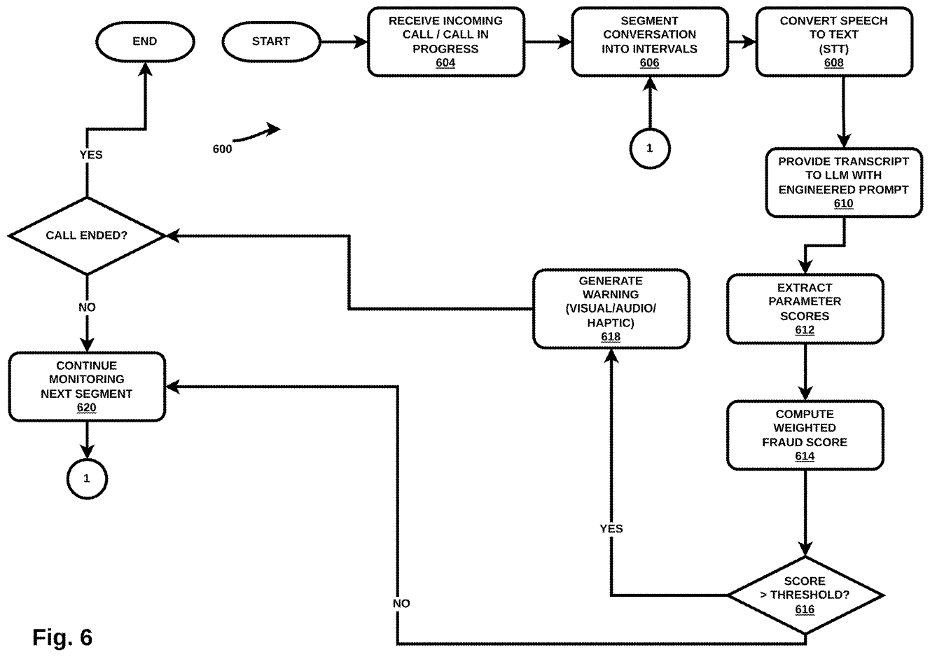

### FIG. 6

FIG. 6 is a flowchart of a method 600 for real-time fraudulent call detection. The method 600 may be performed by a computing device, such as a smartphone, tablet, or other mobile device, or may be performed by a combination of a local device and a remote server. The method 600 enables real-time analysis of voice calls to detect fraudulent intent and provide warnings to users before sensitive information is disclosed.

The method 600 begins at start block 602. At block 604, the system receives an incoming call or detects that a call is in progress. The call may be received at a mobile phone through a cellular network or VoIP connection. In some embodiments, the system may be configured to analyze all incoming calls, or may be configured to analyze only calls from unknown or untrusted numbers. In other embodiments, the system may be configured to analyze calls only when enabled by the user, such as through a user interface setting.

At block 606, the system segments the conversation into intervals. The intervals may be of fixed duration, such as 10 seconds, 20 seconds, or 30 seconds, or may be of variable duration based on conversation pauses or other factors. Segmentation enables progressive analysis of the call as it progresses, rather than waiting until the call ends to provide an assessment.

At block 608, the system converts speech to text using speech-to-text (STT) technology. The speech-to-text conversion may be performed locally on the device using a local transcription model, or may be performed remotely via a cloud-based transcription service. In some embodiments, the speech-to-text conversion may be performed in near-real-time, with the transcript being generated with minimal delay from the spoken audio.

At block 610, the system provides the transcript to an LLM with an engineered prompt. The prompt may be specifically designed to instruct the LLM to evaluate the transcript according to fraud-indicative parameters, such as absence of acquaintance, fake introduction, suspicious context, privacy breach, and urgency. The prompt may include contextual information about the user, the call, and the conversation's progression. The prompt may be dynamically generated based on the specific characteristics of the call and user.

At block 612, the system extracts parameter scores from the LLM output. The parameter scores may include individual scores for each fraud-indicative parameter. In some embodiments, the LLM may output structured data that can be parsed to extract the parameter scores. In other embodiments, the system may parse natural language output from the LLM to extract numerical scores or categorical assessments.

At block 614, the system computes a weighted fraud score. The weighted fraud score may be computed by combining the parameter scores according to a weighted aggregation scheme. The weights may be predetermined based on historical fraud data, or may be dynamically adjusted based on the conversation phase or user characteristics.

At decision block 616, the system determines whether the fraud score exceeds a threshold. The threshold may be a predetermined value, such as 0.7, 0.75, or 0.8 on a scale of 0 to 1, or may be dynamically determined based on user preferences or risk tolerance. If the fraud score exceeds the threshold (YES at block 616), the method proceeds to block 618. If the fraud score does not exceed the threshold (NO at block 616), the method proceeds to block 620.

At block 618, the system generates a warning to the user. The warning may be visual, such as a notification displayed on the device screen with text such as “Potential Fraud Alert” or “This call may be fraudulent.” The warning may be audio, such as a tone or voice message played to the user. The warning may be haptic, such as a vibration pattern that alerts the user without being audible to the caller. In some embodiments, the warning may include additional information, such as the fraud score, specific fraud indicators detected, or a recommendation to end the call.

At decision block 622, the system determines whether the call has ended. If the call has ended (YES at block 622), the method proceeds to end block 624. If the call has not ended (NO at block 622), the method proceeds to block 620.

At block 620, the system continues monitoring the next segment of the conversation. The method loops back to continue analyzing subsequent segments, as indicated by the connector labeled “1.” This enables the system to continuously monitor the call as it progresses and update its assessment based on new information.

The method 600 provides several advantages for real-time fraud detection. By segmenting the conversation and analyzing each segment progressively, the system can provide timely warnings before the user discloses sensitive information. By using weighted scoring of multiple fraud-indicative parameters, the system can achieve high accuracy in detecting fraudulent calls while minimizing false positives. By using an LLM with an engineered prompt, the system can detect sophisticated fraud patterns that may not be detectable through keyword matching or simple rule-based systems.

In some embodiments, the method 600 may include additional steps. For example, the system may store anonymized transcripts and fraud scores for later use in training improved models. The system may also prompt the user for feedback after the call ends, to verify whether the call was actually fraudulent or legitimate.

In alternative embodiments, certain steps of method 600 may be performed in a different order, or certain steps may be combined. For example, blocks 606 and 608 may be combined if the speech-to-text conversion automatically segments the audio into intervals. In another example, blocks 610 and 612 may be combined if the LLM is configured to output structured parameter scores directly without requiring separate extraction.

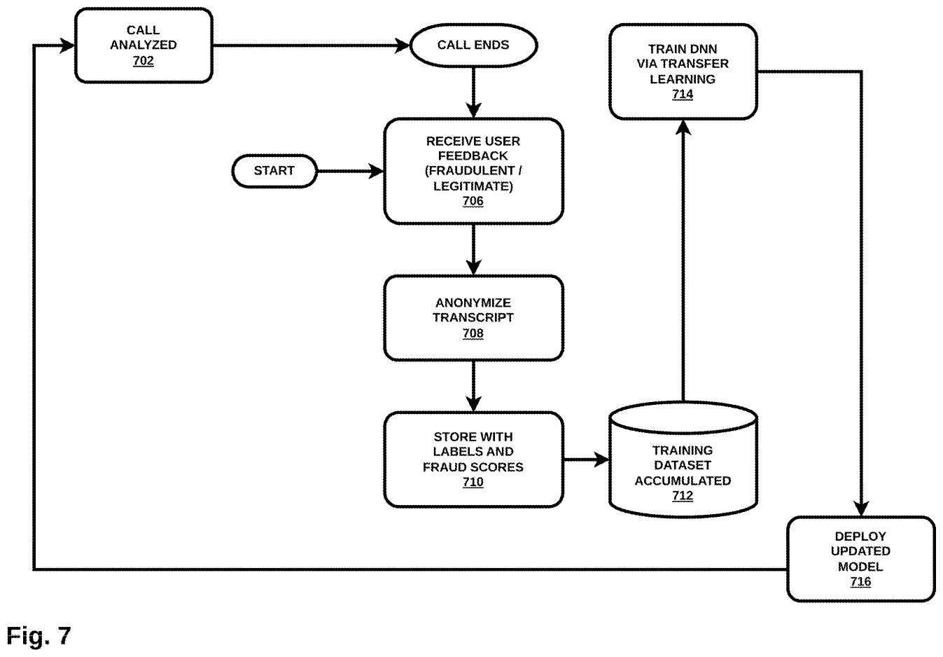

### FIG. 7

FIG. 7 is a flowchart of a feedback and model improvement loop 700. The feedback and model improvement loop 700 enables continuous improvement of the fraud detection system by collecting user feedback and using it to train improved models that can be deployed back to user devices.

The feedback loop 700 begins when a call has been analyzed 702. The call analysis may have been performed using the LLM-based analysis engine described in previous figures, such as the method 600 of FIG. 6. The call analysis may have generated a fraud score, parameter scores, and potentially a warning to the user.

At terminator block 704, the call ends. After the call ends, the system may initiate the feedback collection process. In some embodiments, the feedback collection may be triggered automatically after the call ends. In other embodiments, the feedback collection may be triggered by a user action, such as tapping a notification or opening the security app.

At block 706, the system receives user feedback indicating whether the call was fraudulent or legitimate. The user feedback may be explicit, such as the user selecting an option to indicate that the call was “Fraudulent” or “Legitimate” in response to a prompt. The user feedback may also include additional details, such as the type of fraud (if the call was fraudulent), or the nature of the legitimate call (if the call was legitimate). In some embodiments, the user feedback may be implicit, such as the user blocking the number, reporting the call to authorities, or continuing to interact with the caller after receiving a warning.

At block 708, the system anonymizes the transcript. Anonymization may include removing or obfuscating personally identifiable information, such as names, phone numbers, account numbers, or other sensitive details. Anonymization may help protect user privacy while still preserving the conversational patterns and fraud indicators that are useful for training. In some embodiments, the anonymization may be performed using automated techniques, such as named entity recognition to identify and redact sensitive information.

At block 710, the system stores the anonymized transcript with labels and fraud scores. The stored data may include the anonymized transcript, the fraud score generated by the system, the parameter scores for each fraud indicator, and the user feedback label indicating whether the call was actually fraudulent or legitimate. This stored data may be useful for evaluating the system's accuracy and for training improved models.

At block 712, the training dataset accumulates over time. As more calls are analyzed and more user feedback is collected, the training dataset grows to include a diverse set of fraudulent and legitimate call transcripts with verified labels. The training dataset may include both known fraudulent call examples and known non-fraudulent (legitimate) call examples. The known fraudulent call examples may include transcripts of calls that were confirmed by user feedback or human review to be fraudulent, and may represent various fraud types such as tax scams, tech support scams, lottery scams, romance scams, and others. The known non-fraudulent call examples may include transcripts of calls that were confirmed to be legitimate, such as business calls, personal calls, customer service interactions, and other non-fraudulent communications. Including both fraudulent and non-fraudulent examples in the training dataset enables the model to learn discriminative features that distinguish fraudulent calls from legitimate calls. The training dataset may be stored on a central server or in a distributed manner across multiple devices. In some embodiments, federated learning techniques may be used to train models without centrally aggregating the training data.

At block 714, the system trains a deep neural network (DNN) via transfer learning. The DNN may be trained using the accumulated training dataset, with the labels and fraud scores serving as training targets. In some embodiments, the training may use knowledge distillation, where a teacher model (such as the LLM) provides soft labels and guidance for training a smaller student model (the DNN). The transfer learning process may enable the DNN to achieve high accuracy with limited labeled data by leveraging the knowledge captured in the LLM.

The proportion of fraudulent call examples to non-fraudulent call examples in the training dataset may be adjusted to control the sensitivity and bias of the trained model. In some embodiments, the training dataset may be balanced, with approximately equal numbers of fraudulent and non-fraudulent examples (e.g., a 50/50 ratio). In other embodiments, the training dataset may be intentionally imbalanced to bias the model toward a particular sensitivity profile.

For example, if the training dataset includes a higher proportion of fraudulent call examples relative to non-fraudulent examples, such as a 60/40 ratio (60% fraudulent, 40% non-fraudulent), a 70/30 ratio (70% fraudulent, 30% non-fraudulent), or a 75/25 ratio (75% fraudulent, 25% non-fraudulent), the trained model may become more sensitive to detecting fraud. This increased sensitivity may result in the model being more likely to classify ambiguous calls as fraudulent, potentially generating more false positives (incorrectly flagging legitimate calls as fraudulent) but fewer false negatives (incorrectly classifying fraudulent calls as legitimate). Such a bias may be appropriate for users who prefer to err on the side of caution and receive more warnings, even if some warnings are unnecessary.

Conversely, if the training dataset includes a higher proportion of non-fraudulent call examples relative to fraudulent examples, such as a 60/40 ratio (60% non-fraudulent, 40% fraudulent), a 70/30 ratio (70% non-fraudulent, 30% fraudulent), or a 75/25 ratio (75% non-fraudulent, 25% fraudulent), the trained model may become less sensitive to detecting fraud. This decreased sensitivity may result in the model being less likely to classify ambiguous calls as fraudulent, potentially generating fewer false positives but more false negatives. Such a bias may be appropriate for users who prefer to minimize interruptions and warnings, accepting a higher risk that some fraudulent calls may not be detected.

In some embodiments, different versions of the model may be trained with different class balance ratios, and the appropriate version may be selected based on user preferences, user risk profile, or deployment context. For example, a model trained with a higher proportion of fraudulent examples may be deployed to elderly users who may be more vulnerable to fraud, while a model trained with a higher proportion of non-fraudulent examples may be deployed to users who have indicated a preference for fewer interruptions. In another example, a user may be able to select a sensitivity level through a user interface setting, and the system may select or configure a model with an appropriate training class balance accordingly.

At block 716, the system deploys the updated model. The updated DNN model may be deployed to user devices via over-the-air updates, app updates, or model updates pushed from a central server. The updated model may have improved accuracy compared to previous versions, as it has been trained on additional data and may have learned to detect new fraud patterns.

After deploying the updated model, the feedback loop continues. Future calls analyzed by the system may benefit from the improved model, and the feedback collected from those calls may further improve the training dataset for subsequent model updates. This creates a virtuous cycle of continuous improvement, where each analyzed call contributes to making the system more accurate over time.

In some embodiments, the feedback loop 700 may include additional steps or features. For example, the system may prioritize certain transcripts for human review, such as transcripts where the fraud score was near the threshold (indicating uncertainty) or where the user feedback contradicts the system's assessment. Human-verified labels may be particularly valuable for training, as they may be more accurate than automated labels.

In some embodiments, the feedback loop 700 may operate with differential privacy protections to ensure that individual user data cannot be extracted from the trained model. This may be particularly important for protecting user privacy while still enabling collaborative learning from multiple users' experiences.

In alternative embodiments, the feedback loop 700 may be implemented with variations. For example, the model training may be performed on-device using federated learning, rather than on a central server. In another example, the anonymization may be performed on the user's device before the transcript is uploaded to a central server, providing additional privacy protection.

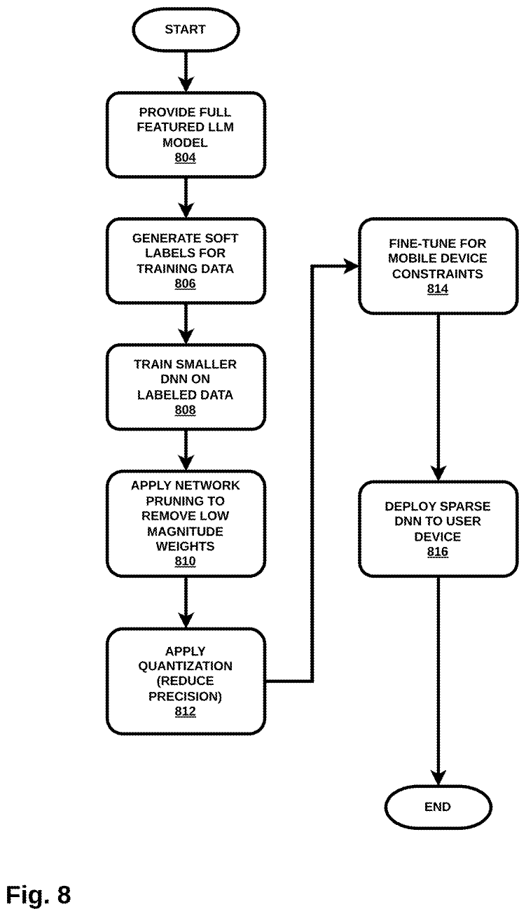

### FIG. 8

FIG. 8 is a flowchart of a method 800 for creating a sparse deep neural network (DNN) for efficient fraud detection on mobile devices. The method 800 enables the creation of a compact, efficient model that can be deployed on resource-constrained devices such as smartphones while maintaining high accuracy in fraud detection.

As used herein, a “sparse deep neural network” or “sparse DNN” refers to a deep neural network in which a substantial proportion of the weight parameters have values of zero or approximately zero. In a dense (non-sparse) neural network, substantially all weight parameters have non-zero values that contribute to the network's computations. In contrast, a sparse DNN has a weight matrix in which many entries are zero, meaning that the corresponding connections between neurons do not contribute to the network's output. The “sparsity” of a sparse DNN may be expressed as the percentage or fraction of weights that are zero. For example, a sparse DNN with 90% sparsity has 90% of its weights set to zero, leaving only 10% of the weights as non-zero values that are stored and used in computations.

Sparse DNNs offer several advantages over dense DNNs for deployment on resource-constrained devices. First, sparse DNNs require less memory to store, as zero-valued weights may be omitted from storage or stored using compressed sparse representations. Second, sparse DNNs may require fewer computational operations during inference, as multiplications by zero weights may be skipped. Third, sparse DNNs may consume less power during execution, as fewer memory accesses and arithmetic operations are required. These advantages make sparse DNNs particularly suitable for deployment on mobile devices, embedded systems, and other resource-constrained environments where memory, processing power, and battery life are limited.

A sparse DNN may be created from a dense DNN through a process called “pruning,” in which weights are selectively removed (set to zero) based on criteria such as magnitude, gradient, or contribution to the network's output. The pruned network may then be fine-tuned through additional training to recover any accuracy lost due to pruning. The resulting sparse DNN may maintain accuracy comparable to the original dense DNN while requiring substantially fewer computational resources.

The method 800 begins at start block 802. At block 804, a full-featured LLM model is provided. The full-featured LLM may be a large language model that has been configured or fine-tuned for fraud detection, such as the LLM engine 308 described with respect to FIG. 3. The full-featured LLM may have billions of parameters and may require significant computational resources to execute.

At block 806, the system generates soft labels for training data. The training data may include call transcripts, such as the training transcripts 502 described with respect to FIG. 5. The full-featured LLM processes each transcript and generates soft labels, which may include probability distributions or continuous scores indicating fraud likelihood and parameter scores for various fraud indicators. Unlike hard labels that simply indicate a binary classification, soft labels capture the LLM's nuanced assessment and uncertainty.

At block 808, the system trains a smaller DNN on the labeled data. The smaller DNN may have significantly fewer parameters than the full-featured LLM, making it more suitable for deployment on mobile devices. The smaller DNN may be trained using supervised learning techniques, where the soft labels from the LLM serve as training targets. In some embodiments, knowledge distillation techniques may be used to train the smaller DNN to mimic the behavior of the LLM. The smaller DNN may learn to approximate the LLM's fraud assessments while requiring substantially less computational resources.

At block 810, the system applies network pruning to remove low-magnitude weights. Network pruning is a technique for reducing the size of a neural network by removing parameters that have minimal impact on the network's output, thereby converting a dense DNN into a sparse DNN. Low-magnitude weights, which may contribute little to the network's predictions, may be identified and set to zero (removed from the network). The pruning process creates sparsity in the weight matrices of the DNN, where a substantial proportion of the weight values become zero. Pruning may significantly reduce the number of non-zero parameters in the DNN, resulting in a sparse DNN that requires less memory and computational resources. In some embodiments, pruning may remove 50%, 70%, 90%, or more of the weights from the DNN while maintaining acceptable accuracy, resulting in a sparse DNN with 50%, 70%, 90%, or greater sparsity respectively.

A sparse DNN, as used herein, refers to a deep neural network in which a substantial proportion of the weight parameters have a value of zero or are removed entirely from the network structure. In contrast, a dense DNN is a neural network in which most or all of the weight parameters have non-zero values. The sparsity of a DNN may be measured as the percentage or fraction of weights that are zero or removed. For example, a DNN with 90% sparsity has 90% of its weights set to zero or removed, meaning only 10% of the original weights remain as non-zero values. Sparsity may be achieved through pruning techniques that identify and remove low-magnitude weights, through regularization techniques that encourage weights to become zero during training (such as L1 regularization), or through sparse training techniques that maintain sparse connectivity from the start of training. Sparse DNNs offer several advantages for deployment on resource-constrained devices: the zero weights may not need to be stored in memory, reducing storage requirements; the zero weights do not need to be loaded or processed during inference, reducing computational cost; and sparse matrix operations may be performed more efficiently than dense matrix operations on hardware that supports sparse operations. The sparse structure of the DNN may be represented explicitly using sparse matrix formats (such as compressed sparse row or compressed sparse column formats) or implicitly using indexing structures that specify only the non-zero weights and their positions.

At block 812, the system applies quantization to reduce precision. Quantization is a technique for reducing the precision of the numerical values stored in a neural network. For example, the network's weights and activations may be stored as 32-bit floating-point numbers in the original model. Quantization may reduce these to 16-bit, 8-bit, or even lower precision representations. Lower precision reduces memory requirements and may enable faster computation, particularly on hardware that supports low-precision arithmetic. In some embodiments, quantization may reduce the model size by a factor of 2, 4, or more with minimal impact on accuracy.

At block 814, the system fine-tunes the model for mobile device constraints. Fine-tuning may include retraining the pruned and quantized model on the training data to recover any accuracy lost during pruning and quantization. Fine-tuning may also include optimizing the model for specific mobile device characteristics, such as the device's processor architecture, available memory, and power constraints. In some embodiments, fine-tuning may include testing the model on representative mobile devices and adjusting the model architecture or parameters to achieve optimal performance.

At block 816, the system deploys the sparse DNN to user devices. The sparse DNN may be significantly smaller and more efficient than the original LLM, enabling deployment on smartphones, tablets, or other mobile devices. The sparse DNN may be capable of performing fraud detection locally on the device, reducing latency and enabling real-time analysis without requiring network connectivity to a remote server. In some embodiments, the sparse DNN may be deployed as part of a security app, a dialer app, or a system-level service.

At block 818, the method ends. The deployed sparse DNN may begin processing call transcripts on the user's device, providing real-time fraud detection warnings to the user.

The method 800 provides several advantages for deploying fraud detection on mobile devices. By creating a smaller, more efficient model, the system enables real-time fraud detection without requiring constant network connectivity to a cloud-based LLM. By applying pruning and quantization, the model can fit within the memory and computational constraints of mobile devices. By fine-tuning after compression, the model can maintain accuracy despite the reduction in parameters and precision.

In some embodiments, the method 800 may include additional steps or variations. For example, the method may include architecture search or architecture optimization to find a DNN architecture that is well-suited to the fraud detection task and the constraints of mobile devices. In another example, the method may include multiple rounds of pruning and fine-tuning, progressively increasing the sparsity while monitoring accuracy.

In some embodiments, different versions of the sparse DNN may be created for different device capabilities. For example, a larger, more accurate model may be deployed to high-end smartphones with more memory and processing power, while a smaller, more efficient model may be deployed to lower-end devices or devices with more limited resources.

In alternative embodiments, the method 800 may be applied to create models for deployment in other contexts beyond mobile devices. For example, the sparse DNN may be deployed on IoT devices, embedded systems, edge computing devices, or telecommunications network equipment. The method 800 may enable fraud detection to be performed at various points in the call path, from the user's device to the network edge to the carrier's infrastructure.

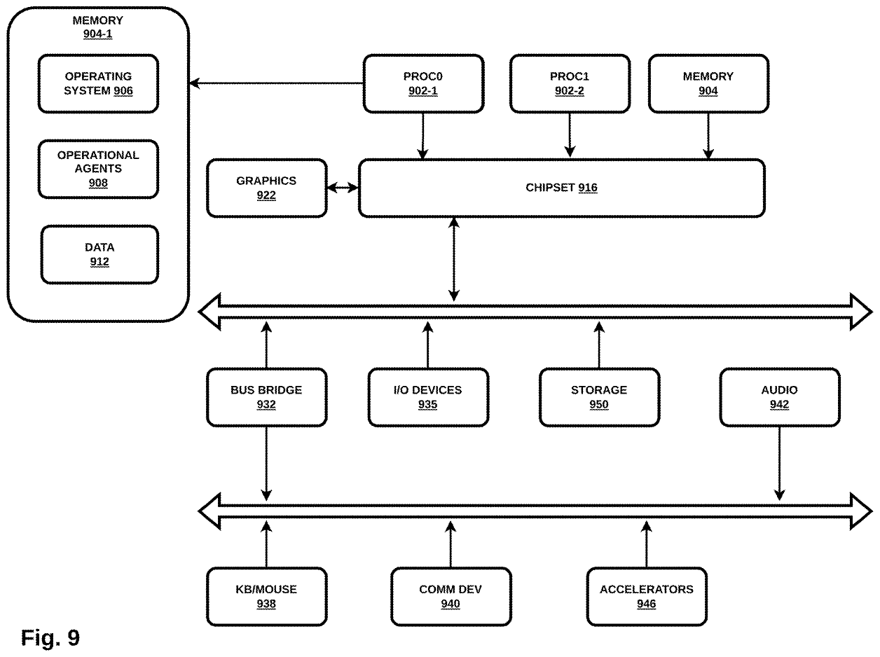

FIG. 9 is a block diagram of a hardware platform 900. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rack-scale architecture” design, disaggregated computing resources may be virtualized into a single instance of a virtual device. In that case, all of the disaggregated resources that are used to build the virtual device may be considered part of hardware platform 900, even though they may be scattered across a data center, or even located in different data centers.

Hardware platform 900 is configured to provide a computing device. In various embodiments, a “computing device” may be or comprise, by way of non-limiting example, a computer, workstation, server, mainframe, virtual machine (whether emulated or on a “bare metal” hypervisor), network appliance, container, IoT device, high-performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smartphone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 900 is arranged in a point-to-point (PtP) configuration. This PtP configuration is popular for personal computers (PCs) and server-type devices, although it is not so limited, and any other bus type may be used.

Hardware platform 900 is an example of a platform that may be used to implement embodiments of the teachings of this specification. For example, instructions could be stored in storage 950. Instructions could also be transmitted to the hardware platform in an intangible or transitory form, such as via a network interface, or retrieved from another source via any suitable interconnect. Once received (from any source), the instructions may be loaded into memory 904, and may then be executed by one or more processors 902 to provide elements such as an operating system 906, operational agents 908, or data 912.

Hardware platform 900 may include several processors 902. For simplicity and clarity, only processors PROC0 902-1 and PROC1 902-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 902 may be any type of processor and may communicatively couple to chipset 916 via, for example, PtP interfaces. Chipset 916 may also exchange data with other elements, such as a high-performance graphics adapter 922. In alternative embodiments, any or all of the PtP links illustrated in FIG. 9 could be implemented as any type of bus, or other configuration rather than a PtP link. In various embodiments, chipset 916 may reside on the same die or package as a processor 902 or on one or more different dies or packages. Each chipset 916 may support any suitable number of processors 902. A chipset 916 (which may be a chipset, uncore, Northbridge, Southbridge, or other suitable logic and circuitry) may also include one or more controllers to couple other components to one or more central processor units (CPUs).

Two memories, 904-1 and 904-2, are shown, connected to PROC0 902-1 and PROC1 902-2, respectively. As an example, each processor is shown connected to its memory in a direct memory access (DMA) configuration, though other memory architectures are possible, including ones in which memory 904 communicates with a processor 902 via a bus. For example, some memories may be connected via a system bus, or in a data center, memory may be accessible in a remote direct memory access (RDMA) configuration.

Memory 904 may include any form of volatile or nonvolatile memory, including, without limitation, magnetic media (e.g., one or more tape drives), optical media, flash, random access memory (RAM), double data rate RAM (DDR RAM), nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory regions, read-only memory (ROM), flash memory, removable media, tape drives, cloud storage, or any other suitable local or remote memory component or components. Memory 904 may be used for short-, medium-, and/or long-term storage. Memory 904 may store any suitable data or information utilized by platform logic. In some embodiments, memory 904 may also comprise storage for instructions that may be executed by the cores of processors 902 or other processing elements (e.g., logic resident on chipsets 916) to provide functionality.

In certain embodiments, memory 904 may comprise a relatively low-latency volatile main memory, while storage 950 may comprise a relatively higher-latency nonvolatile memory. However, memory 904 and storage 950 need not be physically separate devices, and in some examples may represent simply a logical separation of function (if there is any separation at all). It should also be noted that although DMA is disclosed by way of nonlimiting example, DMA is not the only protocol consistent with this specification, and other memory architectures are available.

Certain computing devices provide main memory 904 and storage 950, for example, in a single physical memory device, and in other cases, memory 904 and/or storage 950 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, firmware, services, drivers, interfaces, components, modules, algorithms, sensors, microcode, programmable logic, or objects that can coordinate to achieve a logical operation.

Graphics adapter 922 may be configured to provide a human-readable visual output, such as a command-line interface (CLI) or graphical desktop, including but not limited to Microsoft Windows, Apple OSX, or a Unix/Linux X Window System-based desktop. Graphics adapter 922 may provide output in any suitable format, such as coaxial output, composite video, component video, video graphics array (VGA), or digital outputs, including, without limitation, digital visual interface (DVI), FPDLink, DisplayPort, or high-definition multimedia interface (HDMI). In some examples, graphics adapter 922 may include a hardware graphics card, which may have its own dedicated memory and its own graphics processing unit (GPU).

Chipset 916 may be in communication with a bus 928 via an interface circuit. Bus 928 may have one or more devices that communicate over it, such as a bus bridge 932, I/O devices 935, accelerators 946, communication devices 940, and a keyboard and/or mouse 938, by way of nonlimiting example. In general terms, the elements of hardware platform 900 may be coupled together in any suitable manner. For example, a bus may couple any of the components together. A bus may include any known interconnect, such as a multi-drop bus, a mesh interconnect, a fabric, a ring interconnect, a round-robin protocol, a point-to-point (PtP) interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 940 can broadly include any communication not covered by a network interface and the various I/O devices described herein. This may include, for example, various universal serial bus (USB), FireWire, Lightning, or other serial or parallel devices that provide communication.

I/O devices 935 may be configured to interface with any auxiliary device that connects to hardware platform 900 but is not necessarily a part of the core architecture of hardware platform 900. A peripheral may be operable to provide extended functionality to hardware platform 900, and may or may not be wholly dependent on hardware platform 900. In some cases, a peripheral may be a computing device in its own right. Peripherals may include input and output devices such as displays, terminals, printers, keyboards, mice, modems, data ports (e.g., serial, parallel, USB, FireWire, or similar), network controllers, optical media, external storage, sensors, transducers, actuators, controllers, data acquisition buses, cameras, microphones, speakers, or external storage, by way of nonlimiting example.

In one example, audio I/O 942 may provide an interface for audible sounds, and may include, in some examples, a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 932 may be in communication with other devices, such as a keyboard/mouse 938 (or other input devices, such as a touch screen, trackball, etc.), communication devices 940 (such as modems, network interface devices, peripheral interfaces like PCI or PCIe, or other types of communication devices that may communicate through a network), audio I/O 942, a data storage device 944, and/or accelerators 946. In alternative embodiments, any portions of the bus architectures could be implemented with one or more point-to-point (PtP) links.

Operating system 906 may be, for example, Microsoft Windows, Linux, UNIX, Mac OS X, IOS, MS-DOS, or an embedded or real-time operating system (including embedded or real-time flavors of the foregoing). In some embodiments, a hardware platform 900 may function as a host platform for one or more guest systems that invoke applications (e.g., operational agents 908).

Operational agents 908 may include one or more computing engines that may include one or more non-transitory computer-readable mediums having stored thereon executable instructions operable to instruct a processor to provide operational functions. At an appropriate time, such as upon booting hardware platform 900 or upon a command from operating system 906 or a user or a security administrator, processor 902 may retrieve a copy of the operational agent (or software portions thereof) from storage 950 and load it into memory 904. Processor 902 may then iteratively execute the instructions of operational agents 908 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic input/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software, by way of non-limiting example.

In some cases, the function of an engine is described in terms of a “circuit” or “circuitry” to perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as object code, assembly language, or high-level languages such as OpenCL, FORTRAN, C, C++, Java, or HTML. These may be used with any compatible operating systems or operating environments. Hardware elements may be designed manually, or with a hardware description language such as Spice, Verilog, and VHDL. The source code may define and use various data structures and communication messages. The source code may be in a computer-executable form (e.g., via an interpreter), or the source code may be converted (e.g., via a translator, assembler, or compiler) into a computer-executable form, or converted to an intermediate form such as bytecode. Where appropriate, any of the foregoing may be used to build or describe appropriate discrete or integrated circuits, whether sequential, combinatorial, state machines, or otherwise.

A network interface may be provided to communicatively couple hardware platform 900 to a wired or wireless network or fabric. A “network,” as used throughout this specification, may include any communicative platform operable to exchange data or information within or between computing devices, including, by way of non-limiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), Fibre Channel, Ethernet, Fibre Channel over Ethernet (FCOE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 900 may be virtualized, in particular, the processor(s) and memory. For example, a virtualized environment may run on OS 906, or OS 906 could be replaced with a hypervisor or virtual machine manager. In this configuration, a virtual machine running on hardware platform 900 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 9 may be combined in a System-on-Chip (SoC) architecture or in any other suitable configuration. For example, embodiments disclosed herein can be incorporated into systems including mobile devices such as smart cellular telephones, tablet computers, personal digital assistants, portable gaming devices, and similar devices. These mobile devices may be provided with SoC architectures in at least some embodiments. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), Field-Programmable Gate Arrays (FPGAs), and other semiconductor chips.

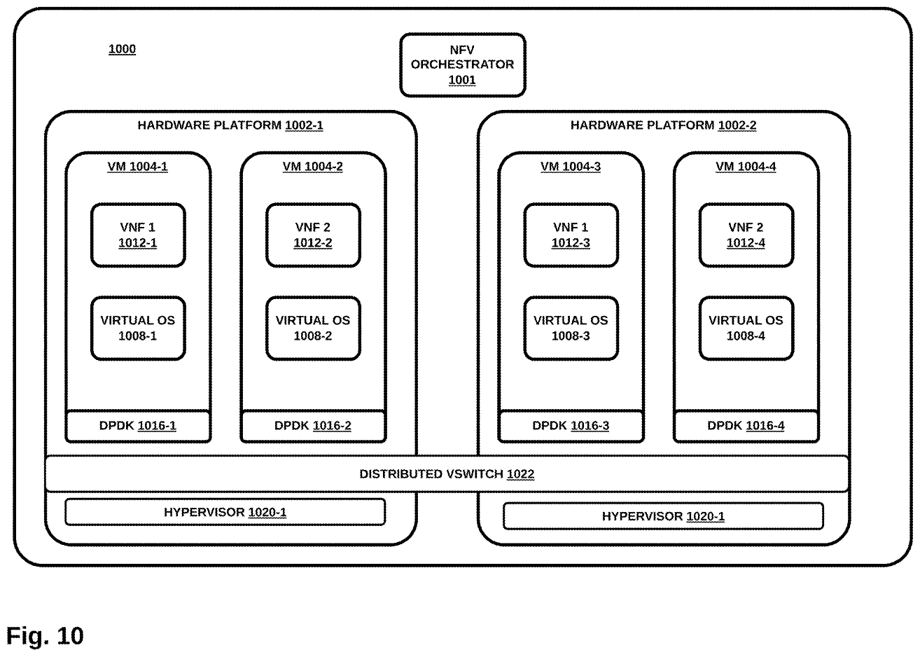

FIG. 10 is a block diagram of an NFV infrastructure, designated as 1000. NFV is an example of virtualization, and the virtualization infrastructure described here can also be used to realize traditional virtual machines (VMs). Various functions described above may be realized as VMs, such as the LLM-based analysis engine, the fraud detection system, or the knowledge distillation system.

NFV is generally considered distinct from Software Defined Networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (CapEx) and operating expenses (OpEx) for telecommunication services. One feature of NFV is replacing proprietary, special-purpose hardware appliances with virtual appliances running on commercial off-the-shelf (COTS) hardware within a virtualized environment. In addition to CapEx and OpEx savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be provisioned.

Because NFV originated as a telecommunications feature, many NFV instances are focused on telecommunications. However, NFV is not limited to telecommunication services. In a broad sense, NFV includes one or more VNFs running within a network function virtualization infrastructure (NFVI), such as the NFVI 1000. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar functions.

In the example of FIG. 10, an NFV orchestrator 1001 may manage several VNFs 1012 running on an NFVI 1000. NFV requires non-trivial resource management, such as allocating a very large pool of compute resources among an appropriate number of instances of each VNF, managing connections between VNFs, determining how many instances of each VNF to allocate, and managing memory, storage, and network connections. This may require complex software management, thus making the NFV orchestrator 1001 a valuable system resource. Note that the NFV orchestrator 1001 may provide a browser-based or graphical configuration interface, and in some embodiments may be integrated with SDN orchestration functions.

Note that the NFV orchestrator 1001 itself may be virtualized (rather than a special-purpose hardware appliance). The NFV orchestrator 1001 may be integrated within an existing SDN system, wherein an operations support system (OSS) manages the SDN. This integration may interact with cloud resource management systems (e.g., OpenStack) to provide NFV orchestration. An NFVI 1000 may include the hardware, software, and other infrastructure to enable VNFs to run. This may include a hardware platform 1002 on which one or more VMs 1004 may run. For example, hardware platform 1002-1 in this example runs VMs 1004-1 and 1004-2, while hardware platform 1002-2 runs VMs 1004-3 and 1004-4. Each hardware platform 1002 may include a respective hypervisor 1020, virtual machine manager (VMM), or similar function, which may run on a native (bare metal) operating system that is minimal so as to consume very few resources. For example, hardware platform 1002-1 has hypervisor 1020-1, and hardware platform 1002-2 has hypervisor 1020-2.

Hardware platforms 1002 may be or comprise a rack or several racks of blade or slot servers (including, e.g., processors, memory, and storage), one or more data centers, other hardware resources distributed across one or more geographic locations, hardware switches, or network interfaces. An NFVI 1000 may also include the software architecture that enables hypervisors to run and be managed by the NFV orchestrator 1001.

Running on NFVI 1000 are VMs 1004, each of which in this example is a VNF providing a virtual service appliance. Each VM 1004 in this example includes an instance of the Data Plane Development Kit (DPDK) 1016, a virtual operating system 1008, and an application providing the VNF 1012. For example, VM 1004-1 has virtual OS 1008-1, DPDK 1016-1, and VNF 1012-1; VM 1004-2 has virtual OS 1008-2, DPDK 1016-2, and VNF 1012-2; VM 1004-3 has virtual OS 1008-3, DPDK 1016-3, and VNF 1012-3; and VM 1004-4 has virtual OS 1008-4, DPDK 1016-4, and VNF 1012-4.

Virtualized network functions could include, as non-limiting and illustrative examples, firewalls, intrusion detection systems, load balancers, routers, session border controllers, Deep Packet Inspection (DPI) services, Network Address Translation (NAT) modules, or security association protocols for calls.

The illustration of FIG. 10 shows that a number of VMs 1004 have been provisioned and exist within NFVI 1000. This FIGURE does not necessarily illustrate any relationship between the VNFs and the larger network, or the packet flows that NFVI 1000 may employ.

The illustrated DPDK instances 1016 provide a set of highly-optimized libraries for communicating across a virtual switch (vSwitch) 1022. Like VMs 1004, vSwitch 1022 is provisioned and allocated by a hypervisor 1020. The hypervisor uses a network interface to connect the hardware platform to the data center fabric (e.g., a host fabric interface (HFI)). This HFI may be shared by all VMs 1004 running on a hardware platform 1002. Thus, a vSwitch may be allocated to switch traffic between VMs 1004. The vSwitch may be a pure software vSwitch (e.g., a shared memory vSwitch), which may be optimized so that data are not moved between memory locations, but rather, the data may stay in one place, and pointers may be passed between VMs 1004 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1022 is illustrated, wherein vSwitch 1022 is shared between two or more physical hardware platforms 1002.

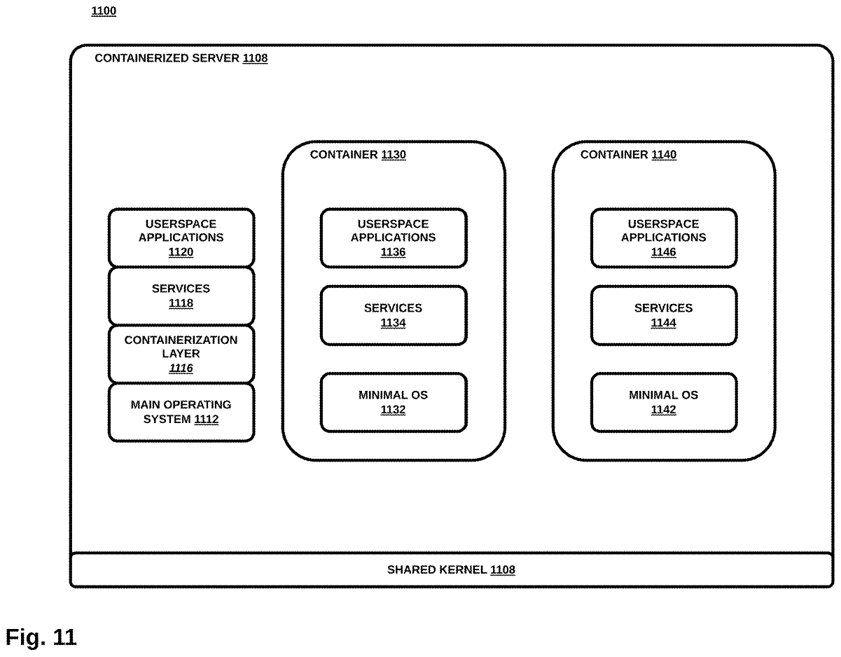

FIG. 11 is a block diagram of selected elements of a containerization infrastructure 1100. Like virtualization, containerization is a popular form of providing a guest infrastructure. Various functions described herein may be containerized, such as the LLM-based analysis engine, the speech-to-text engine, or the fraud detection service.

Containerization infrastructure 1100 runs on a hardware platform, such as a containerized server 1104. Containerized server 1104 may provide processors, memory, one or more network interfaces, accelerators, and/or other hardware resources.

Running on containerized server 1104 is a shared kernel 1108. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1108 is main operating system 1112. Commonly, main operating system 1112 is a Unix or Linux-based operating system, although containerization infrastructure is also available for other types of systems, including Microsoft Windows systems and Macintosh systems. Running on top of main operating system 1112 is a containerization layer 1116. For example, Docker is a popular containerization layer that runs on a number of operating systems and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman, which provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification refers to containerization, it is intended to include any containerization layer, whether it requires the use of a daemon or not.

Main operating system 1112 may also provide services 1118, which provide services and facilitate interprocess communication for userspace applications 1120.

Services 1118 and userspace applications 1120, in this illustration, are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1112, they inherit the same file and resource access permissions as those provided by the shared kernel 1108. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun-up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of a containerized server 1104, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e., the containerized server 1104).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare-metal,” hypervisors—provide such near-native performance that this advantage may not always be realized.

In this example, containerized server 1104 hosts two containers, namely container 1130 and container 1140.

Container 1130 may include a minimal operating system 1132 that runs on top of the shared kernel 1108. Note that a minimal operating system is provided as an illustrative example, and is not mandatory. In fact, container 1130 may perform as a full operating system as is necessary or desirable. Minimal operating system 1132 is used here as an example simply to illustrate that in common practice, the minimal operating system necessary to support the function of the container (which, in common practice, is a single or monolithic function) is provided.

On top of minimal operating system 1132, container 1130 may provide one or more services 1134. Additionally, on top of services 1134, container 1130 may also provide userspace applications 1136, as necessary.

Container 1140 may include a minimal operating system 1142 that runs on top of the shared kernel 1108. Note that a minimal operating system is provided as an illustrative example, and is not mandatory. In fact, container 1140 may perform as a full operating system, as is necessary or desirable. Minimal operating system 1142 is used here as an example simply to illustrate that in common practice, the minimal operating system necessary to support the function of the container (which, in common practice, is a single or monolithic function) is provided.

On top of minimal operating system 1142, container 1140 may provide one or more services 1144. Additionally, on top of services 1144, container 1140 may also provide userspace applications 1146, as necessary.

Using containerization layer 1116, containerized server 1104 may run discrete containers, each one providing the minimal operating system and/or services necessary to provide a particular function. For example, containerized server 1104 could include a mail server, a web server, a secure shell server, a file server, a weblog, cron services, a database server, and many other types of services. In theory, these could all be provided in a single container, but security and modularity advantages are realized by providing each of these discrete functions in a separate container with its own minimal operating system necessary to support those services.

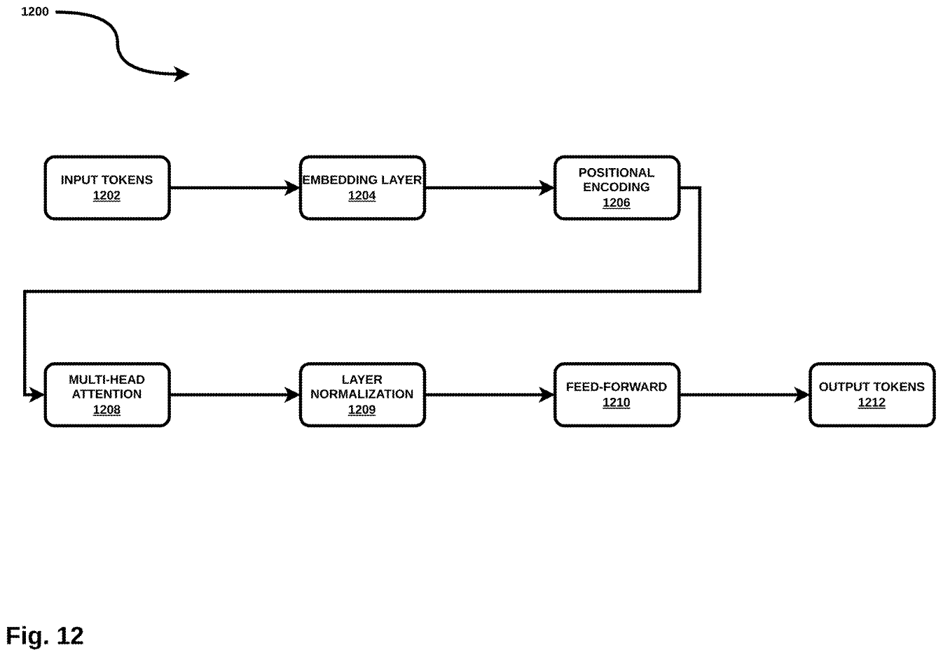

FIG. 12 illustrates selected elements of a transformer-based machine learning architecture 1200. The transformer has become one of the most widely used artificial intelligence (AI) and machine learning (ML) architectures, particularly in applications involving sequential data such as natural language, time-series information, symbolic data, or images.

The embodiment shown in FIG. 12 is a simplified representation of a transformer configured for inference. It illustrates the overall processing pipeline, but omits certain auxiliary mechanisms (e.g., dropout, masking, layer stacking) for clarity. Numerous variations are possible, including different numbers of layers, different normalization strategies, cross-attention modules, and specialized output heads. The illustration is intended to introduce baseline concepts and vocabulary, and is not necessarily an exhaustive or comprehensive treatise on AI technology.

Architecture 1200 receives as input a sequence of tokens 1202. The notion of a “token” is flexible and domain-dependent. Tokens may represent, for example:
Natural language units, such as words, subwords, or characters.
   In many large language models, subword units produced by Byte Pair Encoding (BPE) or SentencePiece tokenization are preferred. These allow common words (e.g., “house”) to remain whole tokens, while rare or novel words (e.g., “houseboatbuilding”) are decomposed into smaller fragments.
   Character-level tokenization may be used in morphologically rich languages or settings where out-of-vocabulary robustness is critical.
Vision tokens, such as fixed-size image patches (e.g., 16×16 pixels).
   In vision transformers (ViTs), an image of size 224×224 pixels would yield 196 tokens. Each patch is flattened and linearly projected into the embedding space.
   Alternative embodiments may instead tokenize images into overlapping patches, wavelet coefficients, or other structured representations.
Numerical or symbolic values, such as time-series samples, sensor readings, or molecular symbols.
   For time-series, tokens might correspond to discretized time windows or quantized amplitudes.
   In cheminformatics, tokens might represent atoms, bonds, or higher-order molecular motifs.

Tokens provide a discrete representation of the input domain, serving as a bridge between raw data and the continuous computations of neural networks.

Each token is typically mapped to a unique identifier from a vocabulary. Input tokens 1202 are then passed to an embedding layer 1204, which maps each discrete identifier into a dense vector in a continuous high-dimensional space. This embedding step transforms symbolic identities into numeric arrays suitable for matrix computations on modern hardware accelerators.

Embeddings are learned parameters, adjusted during training so that semantically or structurally related tokens are placed close to one another in the embedding space.

For example, in a trained natural language model, the embeddings of “king” and “queen” may be relatively close under cosine similarity, while “cat” and “dog” may occupy a nearby region distinct from “car” or “engine.”

In a vision model, embeddings for similar patch types (e.g., sky patches with similar blue gradients) may converge to related regions.

Embedding dimensionality d_{model} is a design choice, commonly ranging from 128 in small models to 4096 or more in large-scale models. A larger d_{model} increases the expressive power of the representation but requires more memory and compute. Some embodiments employ low-rank factorization or quantized embeddings to reduce cost while preserving accuracy.

Transformers lack inherent sequential order, unlike recurrent or convolutional architectures. To resolve this, positional encodings 1206 are combined with embeddings, producing vectors that encode both token identity and sequence position. Example approaches include:
Additive approach: A positional vector is added element-wise to the token embedding.
Concatenative approach: The positional encoding is concatenated to the embedding vector, yielding a larger composite representation.
Hybrid approaches: Learned projections may fuse token identity and positional information.

Common techniques include, as illustrative and nonlimiting examples:
Fixed sinusoidal encodings, defined as:

$$P E ( p , 2 i ) = sin ( \frac{p}{1000 {0}^{2 i / {d}_{m o d e l}}} )$$

$$PE ( p , 2 i + 1 ) = cos ( \frac{p}{1000 {0}^{2 i / {d}_{m o d e l}}} )$$

where p is the token position and i indexes embedding dimensions. This scheme ensures that nearby positions have smoothly varying encodings, and it extrapolates gracefully to sequences longer than those seen in training.
Learned positional encodings, in which each position has a trainable embedding vector. This can yield higher accuracy on in-distribution data but may generalize less effectively to longer sequences.
Relative positional encodings, where relationships are encoded as functions of the distance between tokens rather than their absolute indices. Such encodings are particularly effective in long-context language models and in models handling variable-length sequences.
Rotary positional embeddings (RoPE) and other advanced schemes, which integrate position directly into the computation of attention scores rather than the input embeddings.

By combining embeddings and positional encodings, the transformer produces an enriched sequence of vectors that carry both the semantic identity of each token and its structural placement in the overall sequence. These vectors form the input to the subsequent attention layers 1208, allowing the model to compute context-aware representations.

The enriched vectors are passed to a multi-head attention mechanism 1208. Attention enables each token to attend to all others in the sequence, capturing long-range dependencies.

For an input matrix X∈ [symbol] ^{n×d}^{_{model}} (where n is sequence length and d_{model} is embedding dimension):

$$Q = {XW}^{Q} , K = {XW}^{K} , V = {XW}^{V}$$

Scaled dot-product attention is then:

$$Attention ( Q , K , V ) = softmax ( \frac{Q {K}^{T}}{\sqrt{{d}_{k}}} ) V$$

Multi-head attention replicates this mechanism across several heads, each with distinct projection matrices. The heads capture complementary relationships (syntactic, semantic, positional), and their outputs are concatenated and linearly projected.

Additional embodiments may include, for example:
Masked attention, which prevents a token from accessing future tokens, essential in autoregressive generation.
Cross-attention, used in encoder-decoder architectures, where queries come from one sequence and keys/values from another.
Sparse or efficient attention, limiting connections for scalability to long sequences.

To stabilize training and inference, the transformer employs residual connections and layer normalization 1209.
Residuals: The input of a layer is added to its output, ensuring gradient flow in deep networks.
Layer normalization: Normalizes activations across hidden dimensions, reducing variance and accelerating convergence.

In practice, modern architectures vary in ordering:
Pre-norm (LayerNorm before attention/FFN) vs.
Post-norm (LayerNorm after residual addition).

Following attention, outputs are passed through a feed-forward network (FFN) 1210. The FFN is applied independently to each token position, meaning the same transformation is performed in parallel across the sequence, without mixing information between tokens at this stage.

A common formulation is:

$$FFN ( x ) = f ( x {W}_{1} + {b}_{1} ) {W}_{2} + {b}_{2}$$

Where:
x is the input token representation,
W₁∈ [symbol] ^{d}^{_{model}}^{×d}^{_{ff}} and W₂∈ [symbol] ^{d}^{_{ff}}^{×d}^{_{model}} are learned projection matrices,
b₁ and b₂ are bias terms,
f(·) is a nonlinear activation such as ReLU, GeLU, or SwiGLU, and
max(0,·) represents the ReLU nonlinearity.

The FFN typically expands the dimensionality to an intermediate space d_{ff} that is larger than d_{model}, applies a nonlinearity, and then projects back down to d_{model}. For instance, a model with d_{model}=512 may use d_{ff}=2048. This expansion allows the network to represent more complex nonlinear functions while maintaining the same dimensionality at the output.

While the ReLU-based two-layer FFN is considered canonical, numerous alternatives exist:
Activation functions:
   GeLU (Gaussian Error Linear Unit) is widely used in modern language models, offering smoother gradients than ReLU.
   SwiGLU (Switch Gated Linear Unit) introduces multiplicative gating, enabling dynamic modulation of activations.
   SiLU (Swish) and other smooth nonlinearities are sometimes preferred for stability.
Gated FFNs: Instead of a simple ReLU or GeLU, gating mechanisms allow one projection of the input to modulate another:

$${FFN}_{g a t e d} ( x ) = ( x {W}_{a} ) ⊙ σ ( x {W}_{b} ) {W}_{c}$$

where σ is a sigmoid and ⊙ denotes elementwise multiplication. This structure resembles mechanisms in recurrent networks (e.g., LSTMs) and can increase representational flexibility.
Low-rank or factorized FFNs: To reduce computational load, some embodiments use low-rank decompositions of W₁ and W₂ or replace them with convolutional filters for local mixing.
Mixture-of-Experts (MoE) layers: Instead of a single FFN, a router selects among multiple experts, each an FFN with its own parameters. MoE architectures allow extremely large effective model capacity without increasing per-inference compute.

As with attention, the FFN is wrapped in residual connections and normalization layers:
Residual connection: The input to 1210 is added to its output, allowing gradients to flow more effectively and reducing the risk of vanishing or exploding values.
Normalization: Typically layer normalization, either applied before (pre-norm) or after (post-norm) the FFN. Pre-norm variants often yield more stable training for very deep transformers.

Thus, the effective computation can be expressed as:

$$y = x + FFN ( LayerNorm ( x ) ) ( pre - norm )$$

$$Or :$$

$$y = LayerNorm ( x + FFN ( x ) ) ( post - norm ) .$$

Depth and stacking: Some architectures insert multiple FFN layers between attention blocks, though the canonical design uses one.
Dropout: Dropout layers are often inserted between FFN sublayers to mitigate overfitting during training.
Hardware-efficient forms: For inference optimization, FFNs may be quantized (e.g., 8-bit or 4-bit weights) or fused into custom kernels for GPUs/TPUs.
Task-specific adapters: Fine-tuning methods such as LoRA or prefix-tuning may insert small adapter FFNs parallel to 1210, enabling task adaptation without retraining the full model.

In summary, 1210 acts as a position-wise transformation that increases the expressive power of the transformer block, complementing the contextual mixing provided by attention. Together, attention and FFN layers form the repeating unit of transformer architectures, with residual and normalization layers ensuring stability in deep stacks.

Finally, the processed representations are mapped to outputs 1212. Depending on the application, the outputs may include, by way of illustrative and nonlimiting example:
Language modeling: Linear+softmax to predict next-token probabilities.
Classification: Projection into class logits.
Regression: Continuous value outputs.
Sequence-to-sequence: Feeding outputs iteratively back as inputs.

Inference optimizations may include caching key or value projections for faster autoregressive decoding, reducing redundant computation.

Thus, FIG. 12 illustrates a canonical transformer block: tokens embeddings+positional encodings→multi-head attention→residual+normalization→feed-forward→outputs. This structure forms the building block for deep stacks of transformer layers.

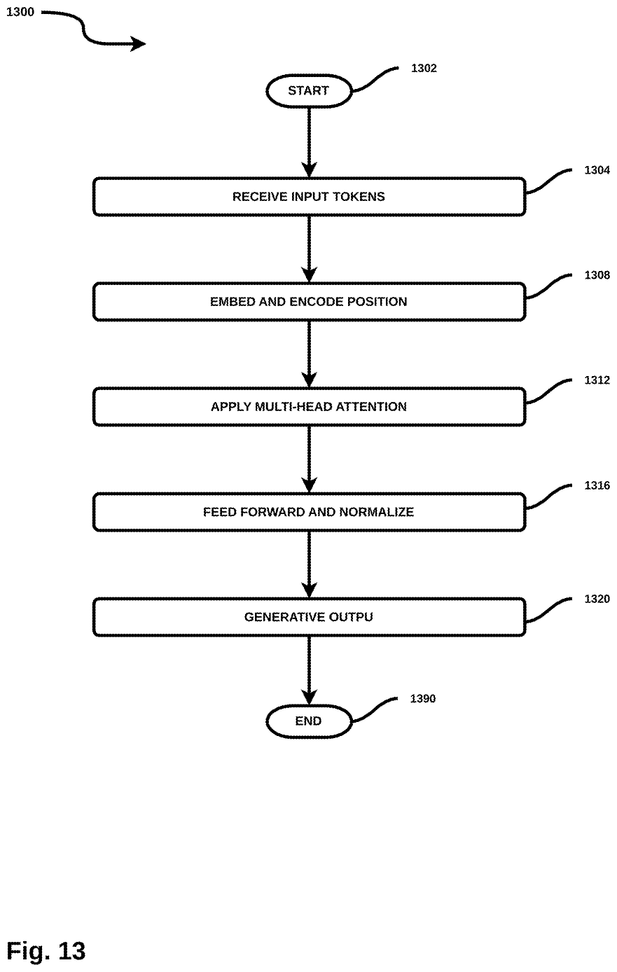

FIG. 13 illustrates a flowchart of method 1300, which describes the inference process of a transformer-based model such as that in FIG. 12. The flowchart abstracts the logical sequence of operations, showing how input tokens are processed to produce outputs. It represents a simplified control flow, suitable for illustrating inference without the complexity of training loops.

In block 1302, inference begins.

Initialization may include loading model parameters from persistent storage (e.g., disk or remote checkpoint repository), allocating GPU/TPU memory buffers, and setting up input/output pipelines. In some embodiments, initialization also involves loading auxiliary assets such as vocabularies, tokenizer configurations, or quantized weight matrices for efficient deployment. For distributed systems, initialization may establish inter-device communication channels (e.g., NCCL, MPI) and synchronize model shards across multiple accelerators.

Unlike training, inference does not update weights-parameters are fixed. However, certain runtime optimizations may still be applied during initialization, such as fusing kernels, precomputing lookup tables, or compiling the model graph with just-in-time (JIT) optimizers. In some cases, initialization includes security checks (e.g., model integrity verification) or policy enforcement before inference is permitted.

In block 1304, input tokens are received. This step bridges raw input data and the internal symbolic representation required by the transformer. The form of tokenization is highly dependent on the domain and the intended task.
Natural language inputs: Raw text is segmented into tokens using algorithms such as Byte Pair Encoding (BPE), WordPiece, or SentencePiece.
   BPE merges frequent character pairs, allowing efficient representation of both common words and rare compounds.
   WordPiece ensures coverage of rare terms by decomposing them into smaller subword units, which improves handling of morphology and out-of-vocabulary words.
   SentencePiece treats whitespace and punctuation uniformly, often using a unigram language model to optimize token boundaries.

Alternative embodiments may use character-level or byte-level tokenization for robustness across multiple languages, or phoneme-based tokenization in speech applications.
Vision inputs: Images are divided into patches of fixed size (e.g., 16×16 or 32×32 pixels). Each patch is flattened and mapped into a token embedding.
   Some models use overlapping patches, multi-scale patches, or convolutional front-ends before tokenization.
   For video, temporal segmentation can produce “spatiotemporal tokens” that capture both spatial regions and frame order.
Symbolic or numerical inputs: Continuous data such as time-series, audio waveforms, or sensor streams are often discretized into tokens.
   Discretization may involve uniform quantization, vector quantization (VQ), or learned codebooks such as VQ-VAE.
   Molecular data, mathematical expressions, or other structured symbolic inputs can be tokenized directly from domain vocabularies (e.g., SMILES strings for chemistry).

This tokenization step ensures that otherwise heterogeneous raw data is mapped into a consistent, discrete vocabulary that the model can embed and process. Preprocessing may also include normalization (e.g., scaling numerical values), filtering (e.g., noise removal), or special markers (e.g., [CLS], [SEP], or end-of-sequence tokens) that guide model behavior.

In some embodiments, additional metadata is encoded alongside tokens, such as modality identifiers in multimodal models (e.g., distinguishing text tokens from image tokens). The resulting token sequence provides a uniform entry point into the embedding layer 1204, guaranteeing compatibility across varying data types and model deployments.

In block 1308, tokens are mapped to embeddings and positional encodings, producing vectors with combined semantic and positional meaning. Each discrete token identifier is transformed into a continuous vector representation via an embedding matrix. These embeddings are learned parameters, optimized during pre-training, and encode relationships between tokens such that semantically or structurally similar items are located near one another in the embedding space.

For example, in a language model, embeddings of words like “cat” and “dog” may occupy a nearby region, while in a vision model, embeddings of image patches containing similar textures (e.g., sky or foliage) may cluster together. In numerical domains, embeddings may capture temporal or categorical structure, enabling the model to treat symbolic inputs as points in a continuous manifold. Embedding dimensionality d_{model} is a design choice: larger values allow richer representation but require more computation and memory.

Because transformers lack a built-in notion of order, positional encodings 1206 are combined with embeddings to incorporate sequence structure. Without positional information, the model would treat an input sequence as a bag of tokens, unable to distinguish “the cat chased the dog” from “the dog chased the cat.”

Several approaches are possible, including for example:
Fixed sinusoidal encodings, which provide continuous, generalizable position information through periodic functions:

$$P E ( p , 2 i ) = sin ( \frac{p}{1000 {0}^{2 i / {d}_{m o d e l}}} ) ,$$

$$PE ( p , 2 i + 1 ) = cos ( \frac{p}{1000 {0}^{2 i / {d}_{m o d e l}}} ) .$$

This allows extrapolation to sequence lengths not observed during training.
Learned positional encodings, where each position has its own trainable vector. This approach adapts well to fixed sequence lengths but may generalize poorly beyond them.
Relative positional encodings, which represent distances between tokens rather than absolute positions, improving handling of long contexts and variable-length sequences.
Rotary embeddings (ROPE) and similar mechanisms, which integrate positional information directly into the computation of attention scores rather than modifying embeddings.

In some embodiments, embeddings and positional encodings are summed element-wise, while in others they are concatenated or fused via learned projections. Multimodal models may also add modality-specific encodings (e.g., “text” vs. “image” identifiers) alongside positional terms, ensuring the model can distinguish sources of information.

The resulting vectors carry both semantic identity and structural position, and form the enriched sequence that proceeds to the multi-head attention mechanism (1312). This step corresponds directly to 1204 (embeddings) and 1206 (positional encodings) in FIG. 12.

In block 1312, the vectors are processed by attention. This step is the core innovation of the transformer architecture, replacing the recurrence of RNNs and the locality of CNNs with a mechanism that allows each token to directly interact with all other tokens in the sequence.

In practice, the enriched input vectors (embeddings plus positional encodings) are linearly projected into three sets of representations:
Queries (Q): which represent the current token's perspective,
Keys (K): which describe how other tokens can be matched against queries, and
Values (V): which contain the information to be aggregated once relevance is determined.

Formally, given input X∈ [symbol] ^{n×d}^{_{model}} (where n is sequence length and d_{model} is embedding dimension):

$$Q = {XW}^{Q} , K = {XW}^{K} , V = {XW}^{V}$$

Where W^{Q}, W^{K}, W^{V} are learned projection matrices. Attention weights are then computed as scaled dot products:

$$Attention ( Q , K , V ) = softmax ( \frac{Q {K}^{T}}{\sqrt{{d}_{k}}} ) V$$

where dₖ is the dimensionality of the keys. This formulation produces a weighted combination of values, with the weights determined by the similarity between queries and keys. Each token thus becomes contextualized by selectively integrating information from all others.

Multi-head attention repeats this process across several parallel “heads,” each with its own learned projections. Different heads can specialize in capturing different types of dependencies—for example, one head might focus on local syntactic relationships, another on long-distance dependencies, and another on positional cues. The outputs of all heads are concatenated and linearly projected back into the model dimension.

Additional embodiments and options include, by way of illustrative and nonlimiting example:
Masked attention: In autoregressive inference (e.g., language generation), attention is restricted so that tokens cannot attend to future positions. This ensures that predictions depend only on already-generated context.
Cross-attention: In encoder-decoder architectures, such as machine translation, queries come from the decoder sequence while keys and values come from the encoder sequence. This allows alignment between source and target sequences.
Sparse or local attention: For very long sequences (e.g., documents with tens of thousands of tokens), efficiency can be improved by limiting attention to nearby tokens, structured windows, or learned patterns.
Rotary or relative encodings: Positional information may be incorporated directly into the QK^{T} similarity computation rather than the embeddings, enhancing performance on long contexts.
Key/Value caching: In inference, keys and values from prior steps are cached to avoid recomputation, dramatically improving throughput in autoregressive decoding.

Attention thus enables each token to build a representation informed by both its local context and long-range dependencies, overcoming the limitations of previous architectures. The contextualized vectors output from 1312 are then passed forward to the feed-forward and normalization stages in 1316.

In block 1316, the attended vectors are passed to feed-forward transformations with normalization. This stage complements the contextual mixing of attention by applying nonlinear transformations independently at each token position. In effect, the feed-forward network (FFN) acts as a per-token “feature processor,” allowing the model to reshape and refine the contextual representations before passing them deeper into the network.

A canonical feed-forward network has the form:

$$FFN ( x ) = f ( x {W}_{1} + {b}_{1} ) {W}_{2} + {b}_{2}$$

where f(·) is a nonlinear activation such as ReLU, GeLU, or SwiGLU. The first projection expands the token representation into a higher-dimensional space (d_{ff}, often 2× to 8× larger than d_{model}), and the second projection brings it back down to d_{model}. This expansion-compression cycle enables the model to learn richer transformations than would be possible in the base embedding dimension alone.

Alternative embodiments include:
Gated FFNs, where one projection modulates another through elementwise multiplication, adding dynamic control to the activation.
Mixture-of-Experts (MoE), where multiple FFNs are available and a lightweight routing mechanism selects a subset per token, greatly expanding model capacity without proportional runtime cost.
Low-rank or factorized FFNs, which approximate the large projection matrices to reduce memory footprint and computation.

To ensure numerical stability in deep stacks, residual connections and layer normalization are applied around the FFN:
Residual connections add the input of the block to its output, preserving information from earlier layers and improving gradient flow.
Layer normalization normalizes activations along hidden dimensions, reducing variance and improving training and inference stability.

Architectures differ in ordering:
Pre-norm: LayerNorm is applied before the FFN, stabilizing gradients in very deep models.
Post-norm: LayerNorm is applied after the residual addition, more common in earlier transformer implementations.

In some embodiments, dropout is applied between FFN layers during training to improve generalization, though it is often disabled during inference. For specialized inference scenarios, such as on-device or low-latency deployment, the FFN may be quantized (e.g., 8-bit or 4-bit weights) or fused into optimized kernels for hardware acceleration.

By combining attention 1312 with feed-forward and normalization 1316, the transformer block balances two complementary operations: global contextual integration and local nonlinear transformation. This alternation enables the network to model both relationships across tokens and sophisticated per-token refinements, yielding powerful and flexible representations for downstream tasks.

In block 1320, the transformer produces an output, such as:
Classification: probability distribution over classes.
Language modeling: distribution over vocabulary tokens.
Regression: continuous values.

For generative tasks, nonlimiting example decoding strategies include:
Greedy decoding (argmax).
Beam search, exploring multiple candidate continuations.
Stochastic sampling (top-k, nucleus sampling), introducing diversity.

Outputs may be appended to inputs, repeating the inference loop until a stop condition (e.g., end-of-sequence token) is met.

In block 1390, inference terminates. Final outputs may be displayed, stored, or provided to downstream pipelines. In generative scenarios, this block occurs after iterative decoding has completed.

Modern deployments may incorporate additional features, including by way of illustrative and nonlimiting example:
Dropout (applied stochastically during inference in some ensembles).
Specialized heads (e.g., span prediction for question answering, multimodal fusion layers).
Quantization or pruning to reduce inference latency.
Hardware acceleration, such as GPUs, TPUs, or dedicated inference ASICs.

The foregoing outlines features of several embodiments so that those skilled in the art may better understand various aspects of the present disclosure. The foregoing detailed description sets forth examples of apparatuses, methods, and systems relating to a system for large language model-assisted fraudulent call detection in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, or with features A, B, and D, or with features D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a non-volatile memory. Thus, for example, an “engine” as described above could include instructions encoded within a volatile or non-volatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, non-transitory computer-readable storage media that contain stored instructions. These instructions, in conjunction with the hardware platform (including a processor) on which they are stored, may constitute a computing apparatus.

In other embodiments, a computing apparatus may also read on an operating device. For example, in this configuration, the “memory” could include a volatile or runtime memory (e.g., RAM), where instructions have already been loaded. These instructions, when fetched by the processor and executed, may provide the methods or procedures as described herein.

In yet another embodiment, there may be one or more tangible, non-transitory computer-readable storage media having stored thereon executable instructions that, when executed, cause a hardware platform or other computing system to carry out a method or procedure. For example, the instructions could be executable object code, including software instructions executable by a processor. The one or more tangible, non-transitory computer-readable storage media could include, by way of illustrative and non-limiting example, a magnetic media (e.g., hard drive), a flash memory, a ROM, optical media (e.g., CD, DVD, Blu-Ray), non-volatile random-access memory (NVRAM), non-volatile memory (NVM) (e.g., Intel 3D XPoint), or other non-transitory memory.

There are also provided herein certain methods, illustrated for example in flow charts and/or signal flow diagrams. The order of operations disclosed in these methods discloses one illustrative ordering that may be used in some embodiments, but this ordering is not intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a non-limiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood in the same manner as the inclusion or exclusion of other elements as described in this paragraph. Where operations are illustrated in a particular order, the order is a non-limiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and any readers of any patent or publication flowing from this specification, the Applicant: (a) does not intend any of the appended claims to invoke paragraph (f) of 35 U.S.C. section 112, or its equivalent, as it exists on the date of the filing hereof, unless the words “means for” or “steps for” are specifically used in the particular claims; and (b) does not intend, by any statement in the specification, to limit this disclosure in any way that is not otherwise expressly reflected in the appended claims, as originally presented or as amended.

1-100. (canceled)

101. A computer-implemented method of detecting fraudulent intent in a telephonic voice call on a user device, comprising:
providing, to a large language model (LLM), a transcript of a portion of an ongoing call between a user and a second party;
receiving, from the LLM, respective parameter scores for a plurality of indicia of fraud associated with the transcript of the call;
computing a weighted fraud score for the ongoing call via a device-local detector of the user device; and
if the weighted fraud score exceeds a threshold, warning the user.

102. The method of claim 101, wherein the plurality of indicia of fraud comprise at least two of: absence of acquaintance, fake introduction, suspicious context, privacy breach, and urgency.

103. The method of claim 101, further comprising generating an engineered prompt for the LLM, the engineered prompt instructing the LLM to evaluate the transcript according to the plurality of indicia of fraud.

104. The method of claim 103, wherein the engineered prompt incorporates contextual data comprising at least one of: user profile information, call metadata, or conversation phase.

105. The method of claim 103, further comprising dynamically adjusting the engineered prompt based on initial segments of the call transcript, wherein as the conversation progresses and additional context becomes available, the prompt is refined to focus on fraud indicators relevant to a detected conversation type.

106. The method of claim 101, wherein computing the weighted fraud score comprises applying respective weights to the parameter scores and aggregating the weighted parameter scores.

107. The method of claim 106, wherein the weights are dynamically adjusted based on a phase of the conversation, the phase comprising at least one of: an introduction phase, a trust-building phase, an urgency phase, or a personal information collection phase.

108. The method of claim 106, wherein the weights are adjusted based on a user profile, the user profile indicating at least one of: user age, financial context, or vulnerability factors.

109. The method of claim 101, wherein the device-local detector is a deep neural network (DNN) having a plurality of weight values.

110. The method of claim 109, wherein the DNN is a neural network architecture selected from the group consisting of: a recurrent neural network (RNN), a long short-term memory (LSTM) network, a gated recurrent unit (GRU), and a transformer-based model.

111. The method of claim 109, wherein the DNN is a sparse DNN.

112. The method of claim 109, further comprising applying network pruning to the DNN to remove low-magnitude weights to create a sparse DNN.

113. The method of claim 109, further comprising applying quantization to the DNN to reduce precision of weight values from 32-bit floating-point to at least one of: 16-bit or 8-bit representations.

114. The method of claim 101, further comprising retraining or retuning the LLM with logged calls that have been previously classified by the method.

115. The method of claim 114, further comprising anonymizing the logged calls by removing or obfuscating personally identifiable information.

116. The method of claim 101, further comprising training a smaller neural network via knowledge distillation from the LLM, wherein the LLM serves as a teacher model and the smaller neural network serves as a student model.

117. One or more tangible, non-transitory computer-readable storage media having stored thereon executable instructions to detect fraudulent intent in a telephonic voice call on a user device, the instructions to instruct a processor to:
provide, to a large language model (LLM), a transcript of a portion of an ongoing call between a user and a second party;
receive, from the LLM, respective parameter scores for a plurality of indicia of fraud associated with the transcript of the call;
compute a weighted fraud score for the ongoing call via a device-local detector of the user device; and
if the weighted fraud score exceeds a threshold, warn the user.

118. The one or more tangible, non-transitory computer-readable storage media of claim 117, wherein the instructions are further to instruct the processor to generate an engineered prompt for the LLM, the engineered prompt instructing the LLM to evaluate the transcript according to the plurality of indicia of fraud.

119. A computing apparatus configured to detect fraudulent intent in a telephonic voice call, comprising:
a hardware platform comprising a processor circuit and a memory; and
instructions encoded within the memory to instruct the processor circuit to:
provide, to a large language model (LLM), a transcript of a portion of an ongoing call between a user and a second party;
receive, from the LLM, respective parameter scores for a plurality of indicia of fraud associated with the transcript of the call;
compute a weighted fraud score for the ongoing call via a device-local detector; and
if the weighted fraud score exceeds a threshold, warn the user.

120. The computing apparatus of claim 119, wherein the LLM has been trained or fine-tuned on samples of known fraudulent and non-fraudulent calls.
